(19) United States
(12) Patent Application Publication
(10) Pub. No.: US 2026/0062252 A1
(43) Pub. Date: Mar. 5, 2026

(54) A PORTABLE FENCE REEL

(71) Applicant: Gallagher Group Limited, Hamilton (NZ)

(72) Inventor: Steven Vincent CORMACK, Hamilton (NZ)

(73) Assignee: Gallagher Group Limited, Hamilton (NZ)

(21) Appl. No.: 19/104,629

(22) PCT Filed: Aug. 18, 2023
(86) PCT No.: PCT/NZ2023/050081

§ 371 Date: Feb. 18, 2025

(30) Foreign Application Priority Data
Aug. 18, 2022 (NZ) 791508

(51) Int. Cl. B65H 75/40; A01K 3/00; B65H 75/44

(52) U.S. Cl. CPC B65H 75/406; A01K 3/001; A01K 3/005; B65H 75/4407; B65H 75/4492

(57) ABSTRACT

A portable fence reel has a reel spool, and a frame including at least one arm, where the reel spool is rotatably mounted to the at least one arm. The fence reel also has a crank shaft, where rotation of a crank shaft results in rotation of the reel spool, and a winding handle. An automatic engaging mechanism includes a coupler rotationally fixed to the crank shaft, and a clutch portion configured to be driven by the winding handle and, in use, move along a longitudinal axis of the crank shaft to engage or disengage with the coupler.

### STATEMENT OF CORRESPONDING APPLCIATIONS

This application is based on New Zealand Patent Application No. 791508, filed 18 Aug. 2022, the entire contents of which are incorporated herein by reference.

### TECHNICAL FIELD

The present disclosure relates to a portable fence reel for the storage and dispensing of fence wire, more particularly a portable fence reel having a wire retraction device, and/or an automatic unspooling mechanism.

### BACKGROUND

Portable electric fencing is an important aspect of livestock and pasture management. It is usually used in animal containment to ensure that livestock do not graze in an undesired area or to set up temporary enclosures for animals to prevent the animals from extensive roaming. By controlling the extent of pasture being grazed by livestock, a farmer is able to sustainably manage pasture growth to ensure a year-round supply of food for livestock. On a regular basis, a farmer will partition off sections of the pasture, to exclude livestock. This allows the pasture to recover from grazing activity. The partitioning of pasture is easily achieved with the use of portable electric fencing.

A portable electric fence consists of three key components; a conductive strand, an energiser to deliver electric pulses over the strand, and one or more fence posts to support the strand. The conductive strand may take many forms, for example a wire, “polywire”, “polybraid”, “polytape” or any other suitable conductive strand used for electric fencing, but for ease of understanding will be referred to herein as a “wire”.

The wire may be stored on a reel and unwound from the reel to span the desired distance and establish a temporary fence line. When unwinding or unspooling the wire from the reel, the user will typically attach one end of the wire to an existing fence line or structure and walk in the desired direction of the fence. This causes the wire to unspool automatically, however the handle of the reel spins around which is both hazardous to the user, and the resulting reel shaking, or oscillating can be a health and safety issue with repetitive use.

Another common method of unspooling the reel is to attach the wire to an existing fence or structure, and the reel to the back of a vehicle, such as a two or four wheeled farm vehicle. The user can then drive in the desired direction, and the reel will automatically unspool. Depending on the speed of the driver, this can cause significant oscillations as the reel handle spins around, which can be both distracting to the driver and potentially damaging to the reel or the farm bike.

Each of the above methods can also be used in reverse, for example the reel may be attached to an existing fence or structure and a user can walk or drive the wire in the desired direction thereby unspooling the wire from the reel. However in these applications, the oscillations resulting from spinning of the handle can cause damage to the fence or structure to which the reel is attached, as well as to the reel itself.

Aspects of the technology of the present disclosure are directed to overcoming one or more of the problems discussed above. It is an object of the present invention to address one or more of the foregoing problems or at least to provide the public with a useful choice.

Further aspects and advantages of the present disclosure will become apparent from the ensuing description which is given by way of example only.

### SUMMARY

According to one aspect of the present technology there is provided a portable fence reel, including:
a reel spool, the reel spool including a barrel, and a first annular flange and a second annular flange at opposing ends of the barrel;
a frame, the frame including:
   at least one arm, wherein the reel spool is rotatably mounted to the at least one arm;
   a handle;
a winding handle configured to be operable by a user to rotate the reel spool;
a drive unit configured to be removably mounted to the frame, the drive unit including:
   a rotary drive;
   a rotary drive user activation device, configured to activate the rotary drive on selection by the user;
   a first drive wheel and a second drive wheel, the first drive wheel and the second drive wheel configured to be driven by the rotary drive when activated,
   wherein the first drive wheel and the second drive wheel contact the first annular flange and the second annular flange respectively in use when the drive unit is mounted to the frame.

According to one aspect of the present technology there is provided a portable fence reel, including:
a reel spool;
a frame, the frame including:
   at least one arm, wherein the reel spool is rotatably mounted to the at least one arm;
   a handle;
a winding handle configured to be operable by a user to rotate the reel spool, wherein the winding handle is configured to be selectively engaged with the reel spool.

According to one aspect of the present technology there is provided a portable fence reel, including:
a reel spool;
a frame, the frame including:
   at least one arm, wherein the reel spool is rotatably mounted to the at least one arm;
   a handle;
a winding handle configured to be operable by a user to rotate the reel spool, wherein the winding handle is configured to engage the reel spool in a first rotary direction, and permit rotation of the reel spool independent of the winding handle in a second rotary direction opposing the first rotary direction.

According to one aspect of the present technology there is provided a portable fence reel, including:
a reel spool;
a frame, the frame including:
   at least one arm, wherein the reel spool is rotatably mounted to the at least one arm;
   a handle;
a winding handle configured to be operable by a user to rotate the reel spool, wherein the winding handle includes:
   a crank and a handle portion at an end of the crank, wherein the handle portion is configured to fold relative to the crank;
   a rotating component to which the crank is connected, and including an internal bore, wherein the crank is configured to pivot between an in-use orientation perpendicular to a longitudinal axis of the internal bore, and a storage orientation aligned with the longitudinal axis of the internal bore,
   wherein the winding handle is configured such that the crank may be slid along the longitudinal axis of the internal bore when in the storage orientation, between a stored position in which the crank is substantially contained within the internal bore, and a retracted position in which the crank is external to the internal bore.

According to one aspect of the present technology there is provided a portable fence reel, including:
a reel spool;
a frame, the frame including:
   at least one arm, wherein the reel spool is rotatably mounted to the at least one arm;
   a handle;
   a securing hook in an inferior position relative to the handle, wherein the securing hook includes a first opening facing in an anterior direction towards the reel spool;
   a barrier configured to be selectively moveable between a closed position in which the barrier extends at least partially across the first opening, and a retracted position in which the barrier is retracted into the frame away from the first opening,
   wherein the barrier is configured to pivot between the closed position and the retracted position; and
a linear actuator configured to move the barrier between the closed position and the retracted position.

According to one aspect of the present technology, there is provided a portable fence reel, including:
a reel spool;
a frame, the frame including at least one arm, wherein the reel spool is rotatably mounted to the at least one arm;
a winding handle configured to be operable by a user to rotate the reel spool; and
an automatic engaging mechanism configured to engage the winding handle with the reel spool when the winding handle is being operated by the user and disengage the winding handle from the reel spool when the winding handle is not being operated by the user.

According to one aspect of the present technology, there is provided a portable fence reel, including:
a reel spool;
a frame, the frame including at least one arm, wherein the reel spool is rotatably mounted to the at least one arm;
a crank shaft, wherein rotation of the crank shaft results in rotation of the reel spool;
a winding handle; and
an automatic engaging mechanism including:
   a coupler rotationally fixed to the crank shaft; and
   a clutch portion configured to be driven by the winding handle and, in use, move along a longitudinal axis of the crank shaft to engage or disengage with the coupler,
wherein the automatic engaging mechanism is configured such that, in use:
   rotation of the winding handle moves the clutch portion between a first position in which the clutch portion is disengaged from the coupler, and a second position in which the clutch portion is engaged with the coupler such that rotation of the winding handle causes rotation of the crank shaft, and therefore the reel spool, and
rotation of the reel spool independently of the winding handle causes the clutch portion to disengage with the coupler to disconnect the winding handle from the crank shaft.

According to one aspect of the present technology, there is provided an automatic engaging mechanism including:
a coupler rotationally fixed to a crank shaft; and
a clutch portion configured to be driven by a handle and, in use, move along a longitudinal axis of the crank shaft to engage or disengage with the coupler,
wherein the automatic engaging mechanism is configured such that, in use:
   rotation of the handle moves the clutch portion between a first position in which the clutch portion is disengaged from the coupler, and a second position in which the clutch portion is engaged with the coupler such that rotation of the winding handle causes rotation of the crank shaft, and therefore the reel spool, and
   rotation of the crank shaft causes the clutch portion to disengage with the coupler to disconnect the handle from the crank shaft.

In examples the rotary drive user activation device may be configured to require actuation by a user in a direction towards the reel spool to activate the rotary drive. In an example the rotary drive user activation device may include a press-button having an actuation axis directed towards the reel spool.

In examples the rotary drive user activation device may be configured to require maintained user actuation for the desired duration of activation of the rotary drive. In examples the rotary drive user activation device may include a momentary switch.

In examples the drive unit may be slidably mounted to the frame. In examples the fence reel may include a rail guide interface between the frame and the drive unit. In examples the rail guide interface may include at least one guide rail and at least one groove, wherein the guide rail may be slidably received within the groove.

In examples the fence reel may include a securing mechanism configured to releasably locate the drive unit in a fixed position relative to the frame. However, in alternative examples the drive unit may be mounted to the frame in a manner which permits free movement along one axis (e.g. in a sliding motion).

In examples, the portable fence reel may include a traverse winder mechanism configured to guide feeding of the wire across the barrel of the reel spool between the annular flanges as the reel spool rotates. In examples, the traverse winder mechanism may include a rotating shaft extending across the reel spool. In examples the rotating shaft may include an external helical track. In examples the helical track may include a right-hand helical portion and a left-hand helical portions joined by reversal portions at ends of the rotating shaft. In examples the pitch of the helical track may vary across the rotating shaft. In examples the pitch of the helical track may be coarser at the centre of the rotating shaft than at the ends of the rotating shaft.

In examples the traverse winder mechanism may include a wire guide carriage including a track follower configured to engage with the helical track in order to guide the wire guide carriage across the shaft as the shaft rotates. In examples the wire guide carriage may include a guide passage configured to locate the wire relative to the carriage.

In an example the traverse winder mechanism may be driven by rotation of the reel spool, directly or indirectly. In an example the traverse winder mechanism may include a bevel gear linkage between the rotating shaft and a bevel gear configured to rotate on rotation of the reel spool.

In examples, the frame may include an anterior frame portion including a posterior facing surface. The anterior frame portion may include a superior raised bearing feature having a first bearing surface. A plane of the first bearing surface may intersect the rotating shaft proximal its longitudinal axis. In examples the wire guide carriage may include an anterior protrusion having a first anterior bearing surface configured to bear against the first bearing surface in use. In examples the posterior facing surface of the anterior frame portion may further include an inferior raised bearing feature having a second bearing surface. In examples an external surface of the wire guide carriage may be configured to bear against the second bearing surface in use.

In examples, the anterior frame portion may include a superior projection extending the width of the travel of the wire guide carriage. In examples the superior projection may have a wire bearing surface that is elevated in comparison with an inferior guide surface of the guide passage.

In examples the frame may include a securing hook in an inferior position relative to the handle. In examples the securing hook may include a first opening facing in an anterior direction towards the reel spool. In examples the frame may include a second opening between the frame and the first opening, wherein the second opening faces a substantially inferior direction. In an example the second opening faces a posterior-inferior direction.

In examples the fence reel may include a barrier configured to be selectively moveable between a closed position in which the barrier extends at least partially across the first opening, and a retracted position in which the barrier is retracted into the frame away from the first opening. In examples the barrier may be configured to pivot between the closed position and the retracted position. In examples the barrier may be actuated by a linear actuator to move between the closed position and the retracted position. In examples the linear actuator includes a biasing means, for example a spring, configured to bias the linear actuator to maintain the barrier in the closed position. In examples the linear actuator may include a push button. In examples the push button may be provided on a posterior facing surface of the frame. In an example the push button may be located in a position inferior to the handle. In an example the push button may be located in a position superior to the securing hook.

In examples, the winding handle may be configured to be selectively engaged with the reel spool. In an example, the winding handle may include a crank configured to be rotated by a user, a rotating component configured to deliver rotary motion to the reel spool, and an intermediary engaging component configured to interface between the crank and the rotating component. In examples, the intermediary engaging component may be selectively engaged and disengaged with at least one of the crank and the rotating component. In examples, the intermediary engaging component may be configured to slide along a longitudinal axis of the rotating component between an engaged position and a disengaged position.

In examples, the winding handle may be configured to engage the reel spool in a first rotary direction, and permit rotation of the reel spool independent of the winding handle in a second rotary direction opposing the first rotary direction. In an example the winding handle may include a one-way clutch (which may also be referred to as a one way bearing, or anti-reverse bearing).

In examples, the winding handle may include a crank and a handle portion at an end of the crank. In examples the handle portion may fold relative to the crank. In examples the crank may include a recess configured to receive the handle portion when folded. In examples the winding handle may include a rotating component to which the crank is connected. In examples the rotating component includes an internal bore. In an example the crank may be configured to pivot between an in-use orientation perpendicular to a longitudinal axis of the internal bore, and a storage orientation aligned with the longitudinal axis of the internal bore. In an example the winding handle may be configured such that the crank may be slid along the longitudinal axis of the internal bore when in the storage orientation, between a stored position in which the crank is substantially contained within the internal bore, and a retracted position in which the crank is external to the internal bore.

Reference to the engaging mechanism being “automatic” should be understood to mean that the operation of the handle causes the mechanism to engage, and/or rotation of the reel while the handle is stationary causes the mechanism to disengage, without separate intervention by the user.

In examples the automatic engaging mechanism may include a stationary reference which is fixed relative to the frame. In examples the stationary reference is configured to interact with the clutch portion to resist rotation of the clutch portion. In examples the crank shaft may pass through the stationary reference. In examples the stationary reference may include at least one wall having an annular radially inward facing surface. In examples the annular radially facing surface may include one or more reference resistance features. In examples the one or more reference resistance features may include corrugations (e.g. alternating ridges and grooves) extending substantially parallel with the longitudinal axis of the crank shaft. In alternative examples the one or more reference resistance features may include a textured surface.

In examples, the clutch portion may include a main body. In examples the main body may include a bore. In examples the bore may be at least partially defined by an annular wall of the main body.

In examples, the clutch portion may include one or more clutch resistance features configured to interact with the stationary reference. For example, the clutch resistance features and stationary reference may be configured to interact to provide the clutch portion with a resistance against rotational movement. In examples the clutch resistance features may interact with the reference resistance features to provide the resistance to rotational movement. In examples the clutch resistance features may include resistance protrusions extending radially outwardly from the clutch portion. In examples each of the clutch resistance features may include a finger. Reference to a finger herein should be understood to mean an elongate member having a first end provided to a base component (for example, the main body), and a free end distal from the first end. In examples the fingers may be provided between sections of the annular wall of the main body. In examples the resistance protrusions may be provided on the finger proximate the free end.

In examples, the clutch resistance features may be moveable between a radially outward position and a radially inward position. In examples, the clutch resistance features may be biased in a radially outward direction. In examples, the fingers may be resiliently deformable—e.g. capable of deflecting radially inwardly under force, and returning in a radially outward direction when the force is reduced. In alternative examples, the clutch resistance features may be provided to a resilient component such as a spring, or resiliently deformable material (e.g. an elastomer).

In examples, the clutch portion and the winding handle may include complementary translation features. In examples, the clutch portion may include one or more protrusions, which are configured to be received by one or more channels in the winding handle. In examples, the clutch portion may include a plurality of protrusions, and the winding handle may include a plurality of channels. In examples, the plurality of protrusions and channels may be evenly spaced so as to provide a multi-start thread. In examples, there may be between 3 and 36 pairs of protrusions and channels. In an alternative example the clutch portion may include the channels and the winding handle may include the protrusions that can interact with the channels. For example, the winding handle may include a plurality of protrusions which are configured to be received by a plurality of channels in the clutch.

In examples, the protrusions and channels may be provided at an angle relative to the axis of rotation of the clutch portion. For example, the angle may be between approximately 40 and 70 degrees as measured from the axis of rotation of the clutch, such as between 50 and 60 degrees, or more preferably approximately 55 degrees. In examples of the technology wherein the protrusions and channels are configured as complementary threads, the angles described here may be equivalent to a helix angle, as should be familiar to those skilled in the art.

In examples the coupler may include an internal aperture with a complementary internal shape to the crank shaft. For example, the crank shaft may have a square or rectangular cross section, and the internal aperture of the coupler may similarly have a corresponding square or rectangular cross section.

In examples, the coupler and clutch portion may include complementary engaging features. For example, the coupler may include coupler teeth and the clutch portion may include clutch teeth configured to engage with the coupler teeth. For example, the complementary engaging features may be configured such that there is positive engagement when the clutch portion is rotated in a first direction relative to the coupler, in order to transfer rotational force from the clutch portion to the coupler.

In examples, the complementary features may be substantially perpendicular to the axis of rotation of the clutch, such that the complementary surfaces do not encourage separation of the clutch from the coupler. In other examples, the complementary features may be configured to encourage translation of the clutch towards the coupler, for example the coupler may include a recess configured to receive a protrusion on the clutch when rotated in a first direction, or vice versa.

In examples, the complementary engaging features (e.g. coupler teeth and clutch teeth) may further include complementary disengaging surfaces which are configured to encourage separation of the clutch portion from the coupler when the coupler is rotated in a second direction relative to the clutch portion, wherein the second direction is opposite to the first direction, such as clockwise and counter-clockwise. For example the complementary disengaging surfaces may be provided on a side of the coupler teeth and/or clutch teeth which is opposite to the complementary engaging surfaces. Additionally, where the coupler is rotating in the same direction as the clutch portion but at a higher rotational velocity than the clutch portion then the complementary disengaging surfaces may encourage disengagement of the clutch in the same manner as if the coupler and the clutch portion were rotating at opposite directions relative to one another, including where one of the clutch portion and the coupler are stationary. This can provide a freewheeling mode of operation where the application of momentary or discrete rotations of the crank handle may result in continuous rotation of the coupler and the reel spool.

In examples the fence reel may include a strand connection feature configured to secure the conductive strand in contact with an electrically conductive portion of the fence reel. In examples, at least one arm of the frame may be made of a conductive material. In alternative examples the frame may include an electrically conductive component. In examples the strand connection feature may include a leading portion having a sloped surface leading from a first position offset from the electrically conductive portion of the fence reel to a second position proximate the electrically conductive portion. In examples the strand connection feature may include at least one guide flange. In examples the strand connection feature may include a guide flange on each lateral side of the leading portion. In examples the at least one guide flange may include a guide edge leading from a side of the electrically conductive portion of the fence reel at which the leading portion is provided, to an opposing side of the electrically conductive portion. In examples the guide edge may slope away from the leading edge. In examples the strand connection feature may include a recess provided at an end of the guide edge distal from the leading portion.

The above and other features will become apparent from the following description and the attached drawings.

### BRIEF DESCRIPTION OF THE DRAWINGS

Further aspects of the present disclosure will become apparent from the following description which is given by way of example only and with reference to the accompanying drawings in which:

FIG. 1A is a bottom perspective view of an exemplary portable fence reel according to one aspect of the present technology.

FIG. 1B is a top perspective view of the exemplary portable fence reel.

FIG. 1C is a front view of the exemplary portable fence reel.

FIG. 1D is a rear view of the exemplary portable fence reel.

FIG. 1E is a bottom view of the exemplary portable fence reel.

FIG. 1F is a top view of the exemplary portable fence reel.

FIG. 1G is a side view of the exemplary portable fence reel.

FIG. 1H is a first perspective view of an exemplary drive unit separated from the exemplary portable fence reel.

FIG. 1I is a second perspective view of the exemplary drive unit separated from the exemplary portable fence reel.

FIG. 2 is a perspective view of the functional components of the exemplary drive unit according to one aspect of the present technology.

FIG. 3A is a front view of an exemplary winding handle and reel spool according to one aspect of the present technology.

FIG. 3B is an exploded view of the exemplary winding handle.

FIG. 3C is an exploded view of an exemplary gearbox for driving the reel spool.

FIG. 4A is a perspective view of an exemplary traverse winder mechanism according to one aspect of the present technology.

FIG. 4B is an exploded view of a portion of the exemplary traverse winder mechanism.

FIG. 4C is a front view of a rotating shaft of the exemplary traverse winder mechanism.

FIG. 5A to 5E are views of an exemplary barrier mechanism according to one aspect of the present technology.

FIGS. 6A and 6B are views of another exemplary winding handle according to one aspect of the present technology.

FIG. 7A to 7C are views of another exemplary winding handle according to one aspect of the present technology.

FIGS. 8A and 8B are exploded perspective views of an automatic engaging mechanism according to one aspect of the present technology.

FIGS. 8C and 8D are views of a clutch portion of the automatic engaging mechanism according to one aspect of the present technology.

FIG. 8E to 8G are views of a coupler portion of the automatic engaging mechanism according to one aspect of the present technology.

FIG. 9A to 9D are views of the automatic engaging mechanism in an assembled state according to one aspect of the present technology.

FIG. 10 to 10D are views of another exemplary portable fence reel according to one aspect of the present technology.

FIG. 10E to 10H are views of an exemplary strand connection feature in accordance with one aspect of the present technology.

FIG. 11A to 11D are views of another exemplary traverse winder mechanism according to one aspect of the present technology.

### DETAILED DESCRIPTION

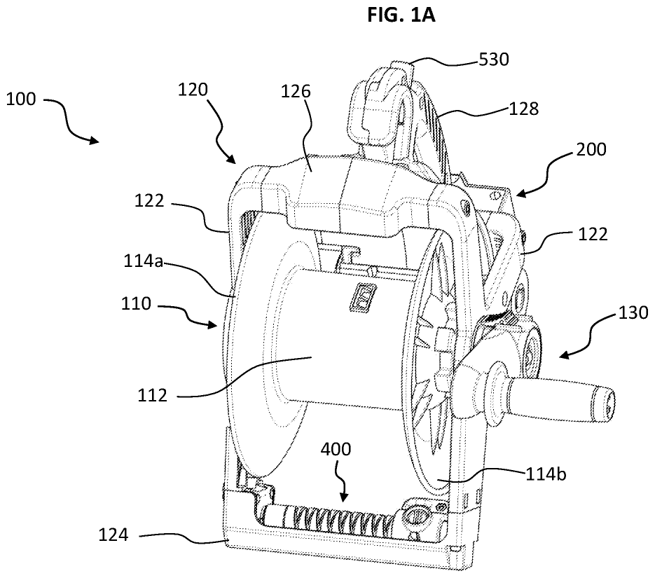

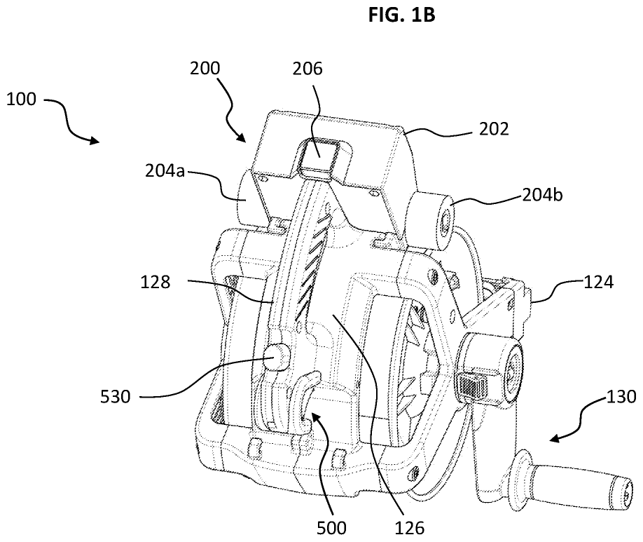

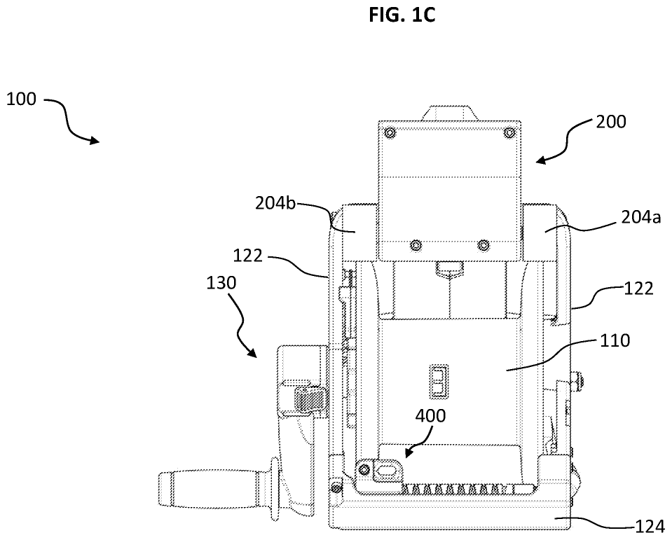

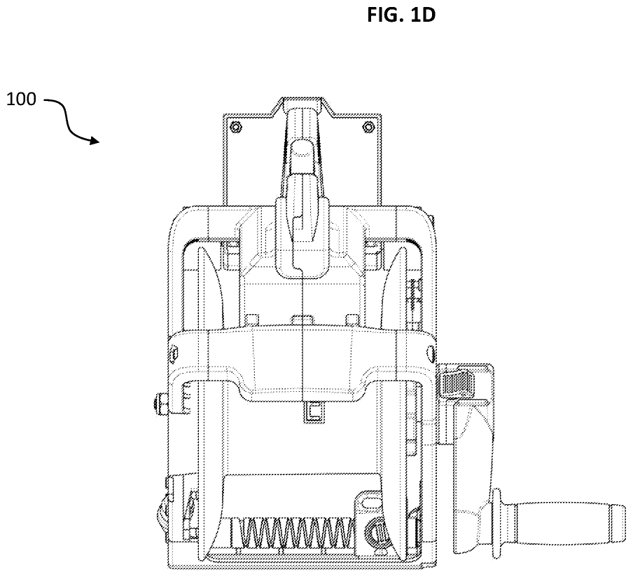

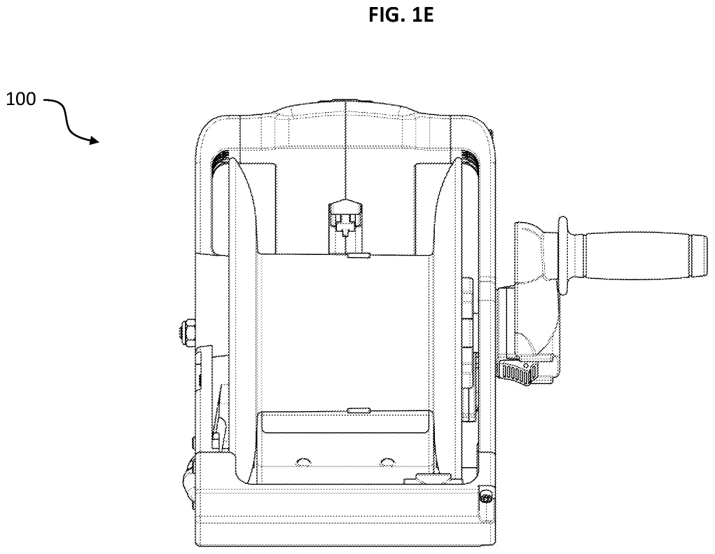

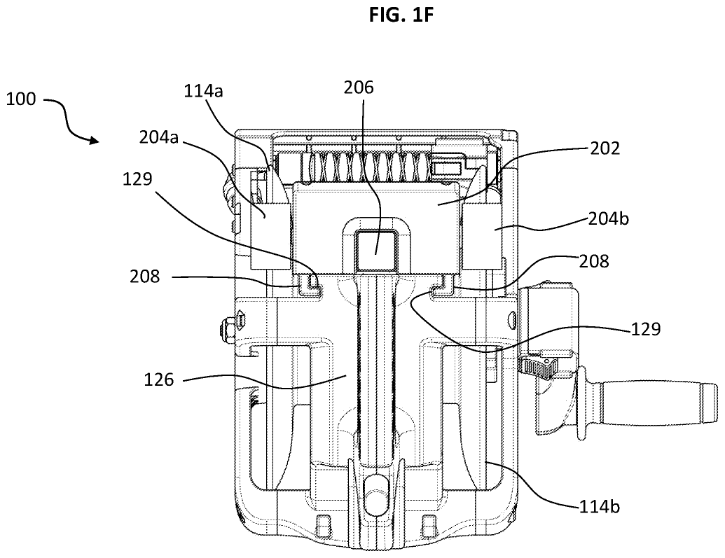

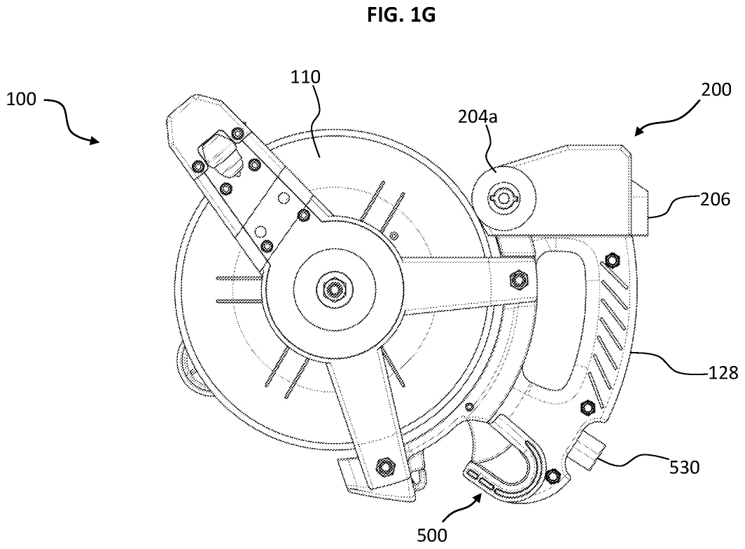

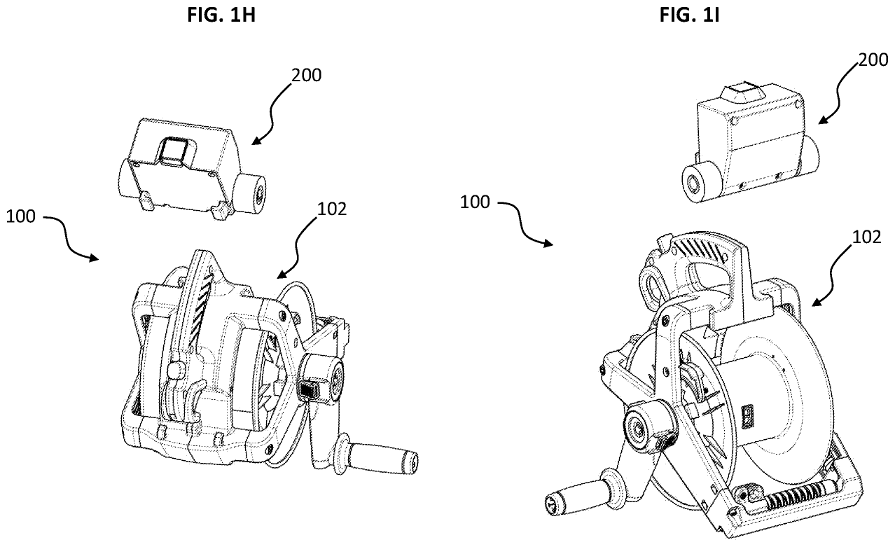

FIG. 1A to FIG. 1I illustrate a portable fence reel 100 according to one aspect of the present technology. The fence reel 100 includes a base unit 102, including a reel spool 110, the reel spool 110 including a barrel 112, and a first annular flange 114a and a second annular flange 114b at opposing ends of the barrel 112. The base unit 102 of the fence reel 100 includes a frame 120, the frame 120 including lateral frame portions 122—in this example including a superior arm portion, an anterior arm portion, and a posterior arm portion. The lateral frame portions 122 are joined by an anterior frame portion 124, and a posterior frame portion 126. A fixed handle 128 is provided on the posterior frame portion 126, for handling of the fence reel 100.

In this example, a portion of the posterior frame portion 126 inferior to the fixed handle 128 includes an enlarged surface area. This enlarged surface area is substantially flat and angled to face in an inferior-posterior direction so as to comfortably rest against the leg of a user when winding wire in with the reel.

The reel spool 110 is rotatably mounted between the lateral frame portions 122. The fence reel 100 further includes a winding handle 130, operable by a user to rotate the reel spool 110 in order to manually reel in a wire affixed to the reel spool 110.

In this example, the portable fence reel 100 includes a drive unit 200 configured to be removably mounted to the frame 120 of the base unit 102. The drive unit 200 includes a housing 202, a first drive wheel 204a and a second drive wheel 204b. When mounted to the base unit 102, the first drive wheel 204a and the second drive wheel 204b contact the outer rims of the first annular flange 114a and the second annular flange 114b respectively. Actuation of a rotary drive user activation device in the form of press-button 206 causes the drive wheels 204 to rotate, and act against the annular flanges 114 to rotate the reel spool 110. Referring to FIG. 1F in particular, it may be seen that the drive unit 200 is slidably mounted to the frame 120. In this example, the posterior frame portion 126 includes radially outwardly facing grooves 129 receiving guide rails 208 of the drive unit 200. The orientation of the grooves 129 guides the drive unit 200 onto the reel spool 110 from a superior position, with the force applied by the user to the press-button 206 (in combination with gravity) holding the drive wheels 204 on the annular flanges 114.

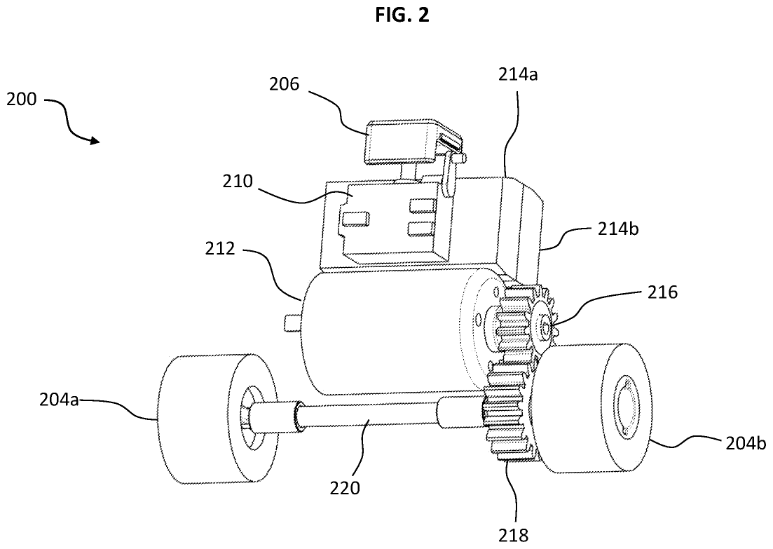

Referring to FIG. 2, the drive unit 200 includes a momentary switch 210 activated by press-button 206. The switch 210 controls activation of a rotary drive in the form of an electric motor 212, powered by one or more batteries 214. In the illustrated embodiment, the electric motor 212 is attached to a pinion gear 216, which in turn drives a larger gear 218 affixed to axle 220, to which first drive wheel 204a and second drive wheel 204b are secured. In other examples, the electric motor may be configured to connect to the axle 220 using a belt drive configuration. In yet further examples, the electric motor may have a direct connection to the axle 220 or the one or more drive wheels. For example, the axle 220 may be configured to pass through the electric motor 212, and attach at a first end to the first drive wheel 204a, and at the second end to a second drive wheel 204b. In a yet further example of the technology, the electric motor may be a hub motor as should be familiar to those skilled in the art.

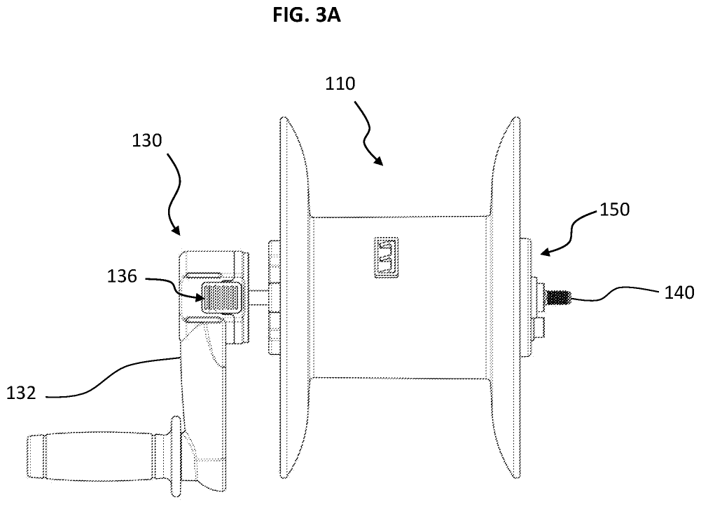

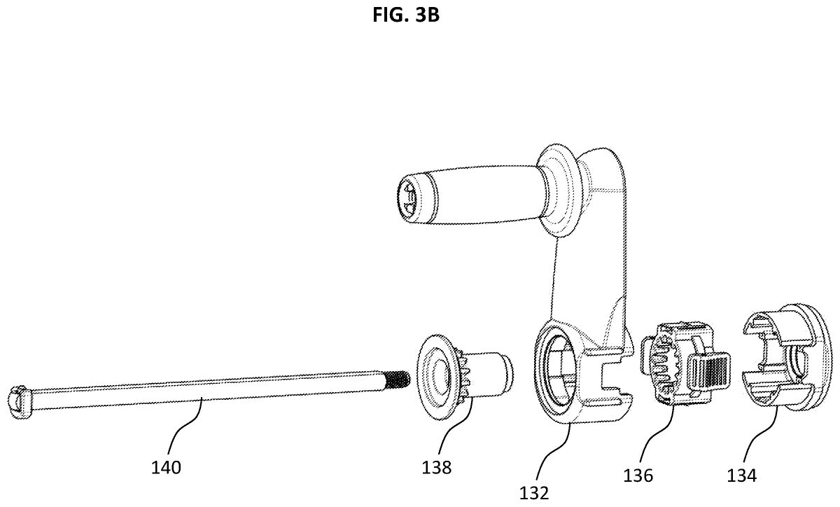

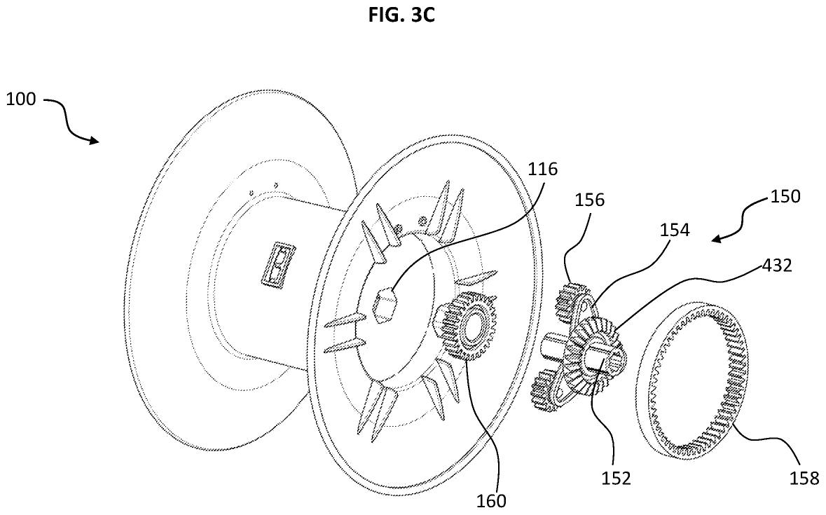

Whether it be during use of the drive unit 200, or unreeling the wire from the fence reel 100, there are many instances in which it would be desirable for the winding handle 130 to not rotate with the reel spool 110. Referring to FIGS. 3A and 3B, in this exemplary embodiment the winding handle 130 may be selectively engaged with the reel spool to enable this. The winding handle 130 includes a crank portion 132 configured to be rotated by a user, connected to a base portion 134. An intermediary engaging component 136 is contained by the crank portion 132 and base portion 134, and permitted to be actuated by the user to slide along a longitudinal axis towards, and away from, the reel spool 110. A rotating component 138 is fixed to the crank shaft 140 for example, by a complementary shape fit therebetween, by keying, welding, or fastening. The rotating component 138 and intermediary engaging component 136 include complementary engaging features (in this example interlocking teeth), which when engaged effectively lock the crank shaft 140 to the crank 132. When the crank 132 is to be isolated from rotation by the reel spool 110, the intermediary engaging component 136 may be slid away from the rotating component 138 to disengage the interlocking teeth.

Rotation of the crank shaft 140 drives a gearbox 150 to rotate the spool. Referring to FIG. 3C, in this example the gearbox includes a planetary gear train, including planet carrier 152 (secured to crank shaft 140) having arms 154 to which planet gears 156 are attached, and a ring gear 158 surrounding the planet gears 156. Sun gear 160 is fixed to the reel spool 110 to drive rotation of the reel spool 110, for example by keying to a drive aperture 116, by joining, fastening, or by moulding the sun gear as part of the reel spool 110, to provide an integral connection therebetween.

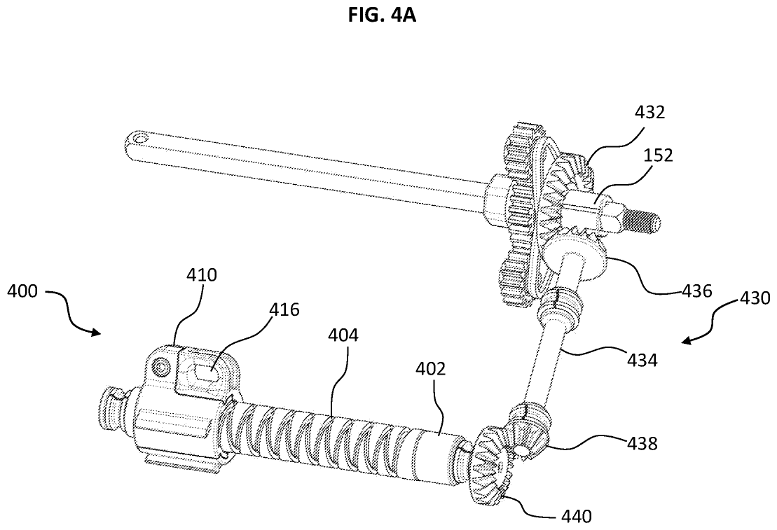

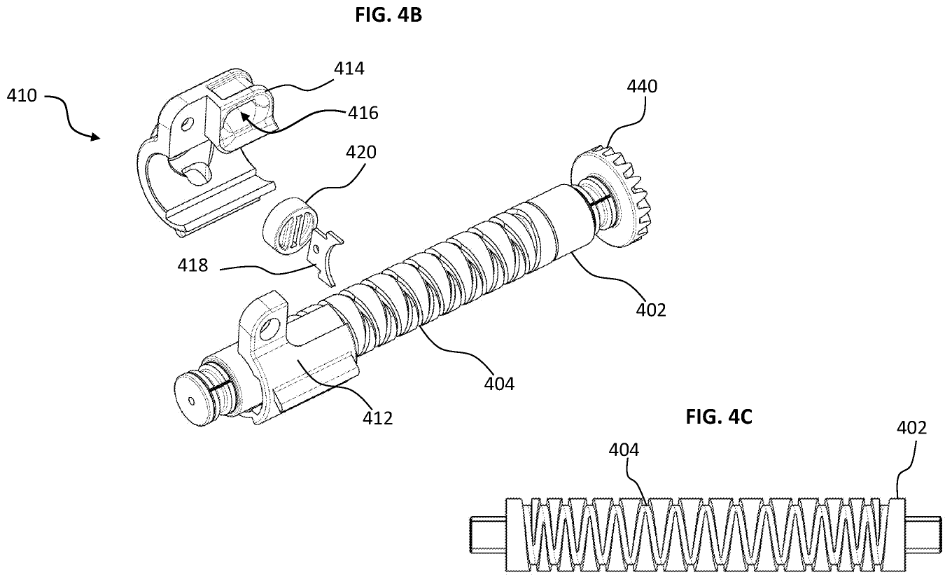

In examples of the technology, to facilitate even winding and unwinding of the wire from the reel spool 110, the base unit 102 of the fence reel 100 includes a traverse winder mechanism 400. Referring to FIG. 4A to 4C, in this example the traverse winder mechanism 400 includes a rotating shaft 402 extending across the reel spool 110 between the lateral frame portions 122. The rotating shaft 402 includes an external helical track 404, having a right-hand helical portion and a left-hand helical portion, joined by reversal portions at ends of the rotating shaft 402. In other words the right-hand helical portion, left-hand helical portion and reversal portions provide a continuous external helical track 404. The traverse winder mechanism 400 further includes a wire guide carriage 410, including an anterior portion 412 and a posterior portion 414 configured to be secured to each other on either side of the shaft 402. The posterior portion 414 includes a guide passage 416 configured to locate the wire relative to the carriage 410. A track follower portion 418 is configured to engage with the helical track 404 in order to guide the wire guide carriage 410 across the shaft 402 as the shaft 402 rotates, with the track follower portion 418 located relative to the posterior portion 414 by track follower holder 420. In examples the wire guide carriage 410 interacts with the anterior frame portion 124 to restrict rotation of the wire guide carriage 410 while allowing translation—for example guide rails, or shaping of the wire guide carriage 410 and the anterior frame portion 124 (e.g. adjacent surfaces that do not permit relative rotation).

Referring to FIG. 4C, in this example the pitch of the helical track 404 varies across the rotating shaft 402, being coarser at the centre of the rotating shaft 402 than at the ends of the rotating shaft 402. The guide passage 416 has to have a sufficient diameter to accommodate the wire, but also knots which may be formed in the wire (particularly where the wire is a polytape, polywire or polybraid). As a result, there can be some movement within the passage 416 such that the wire is not guided in an ideal fashion across the barrel of the spool 110. It is envisaged that the coarseness of the pitch at the centre of the shaft 402 reduces the dwell time at this point, reducing the likelihood of an uneven buildup of wire at the centre of the spool 110 relative to the sides of the spool.

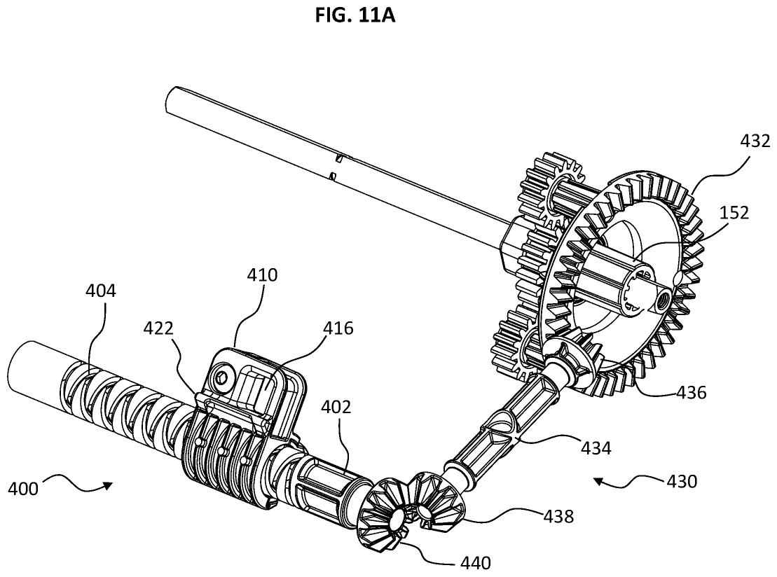

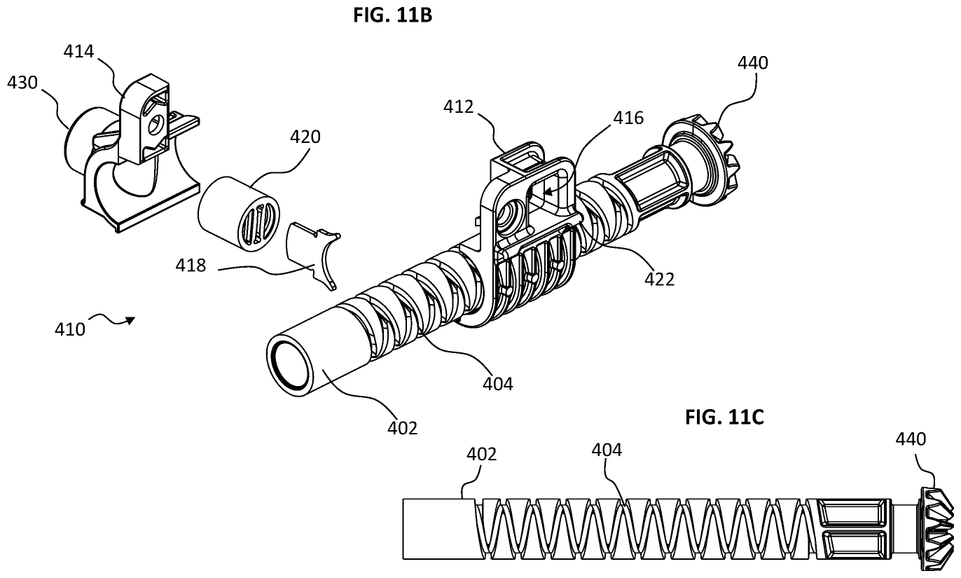

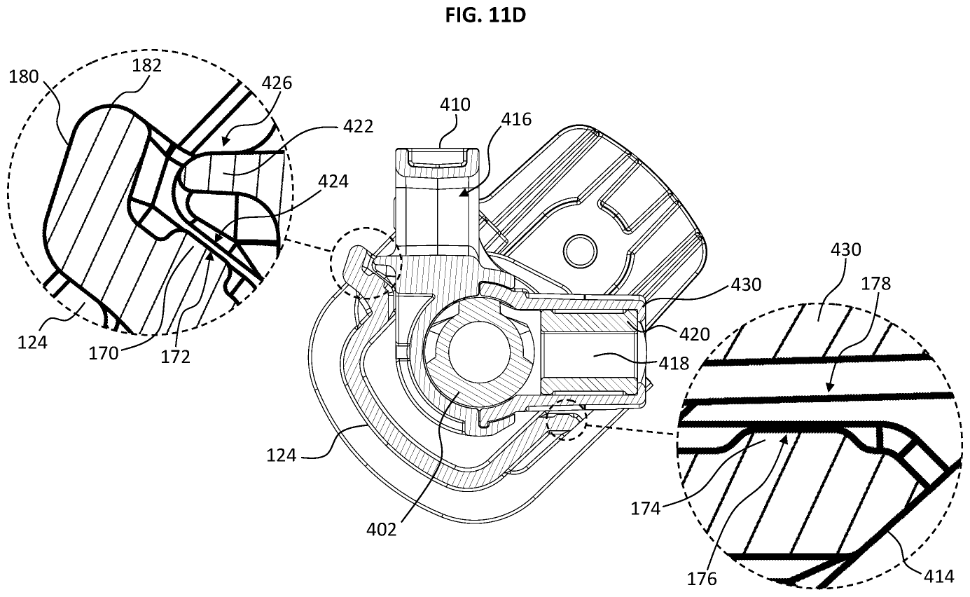

FIG. 11A to 11D illustrate another example of a traverse winder mechanism 400. In this example, the track follower holder 420 is elongate—i.e., its length is greater than its height or width. The posterior component 414 of the wire guide carriage 410 includes a receiving portion 430 having a cylindrical bore into which the track follower holder 420 is fitted, maintaining the track follower holder 420 in an orientation in which its longitudinal axis is perpendicular to a longitudinal axis of the rotating shaft 402, while permitting rotation of the track follower holder 420 about its longitudinal axis. In examples, the receiving portion 430 may include one or more openings (e.g., one or more slots) allowing for egress of dirt and other contaminants from the interior.

In this example, a posterior facing surface of the anterior frame portion 124 includes a superior raised bearing feature 170 having a first bearing surface 172. A plane of the first bearing surface 172 intersects the rotating shaft 402 proximal its longitudinal axis, so the torque imparted by the wire guide carriage 410 is supported by a reaction force more or less normal to the first bearing surface 172. The anterior portion 412 of the wire guide carriage 410 includes an anterior protrusion 422 having a first anterior bearing surface 424. In use, the first anterior bearing surface 424 bears against the first bearing surface 172 when the wire guide carriage 410 rotates towards the first bearing surface 172.

The posterior facing surface of the anterior frame portion 124 further includes an inferior raised bearing feature 174 having a second bearing surface 176. In use, an external surface 178 of the receiving portion 430 of the posterior portion 414 of the wire guide carriage 410 bears against the second bearing surface 176 when the wire guide carriage 410 rotates towards the second bearing surface 176.

In examples, the anterior frame portion 124 includes a superior projection 180 extending the width of the travel of the wire guide carriage 410. The superior projection 180 has a wire bearing surface 182 that is elevated in comparison with an inferior guide surface 426 of the guide passage 416. This arrangement means that the force that the wire imparts on the wire guide carriage 410 is reduced, and thus some of the mechanical demands in overcoming friction placed upon the traverse winder mechanism 400.

Returning to FIG. 4A, the traverse winder mechanism 400 is driven by rotation of the reel spool 110 for example via a drive mechanism such as the illustrated bevel gear linkage 430, a belt or a flexible shaft. In the illustrated example, the bevel gear linkage 430 includes a drive bevel gear or crown gear 432 provided on planet carrier 152. A bevel gear shaft 434 includes a second bevel gear or pinion 436 configured to engage with the drive bevel gear 432 at a first end, and a third bevel gear 438 at a distal end. The third bevel gear 438 engages a fourth bevel gear 440 provided to the rotating shaft 440. As a result, rotation of the reel spool 110-whether by winding handle 130 or drive unit 200-drives rotation of the rotating shaft 402 and therefore translation of the wire guide carriage 410.

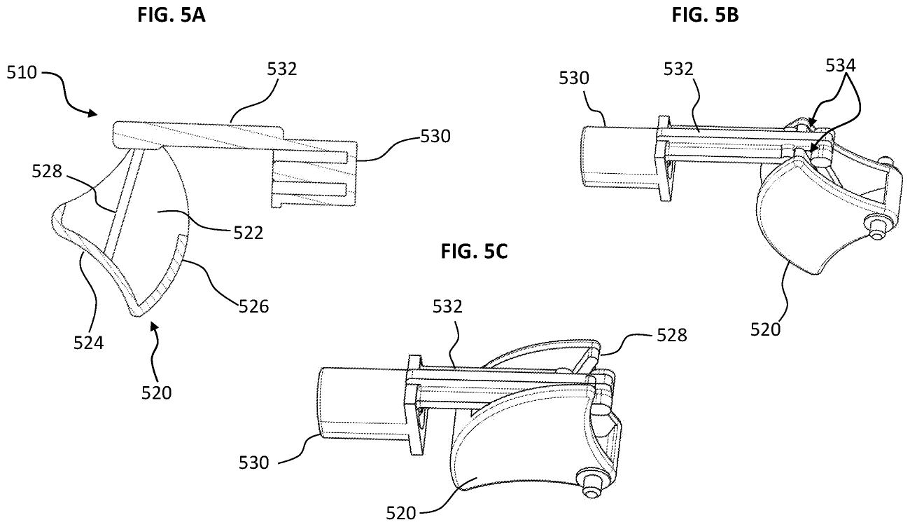

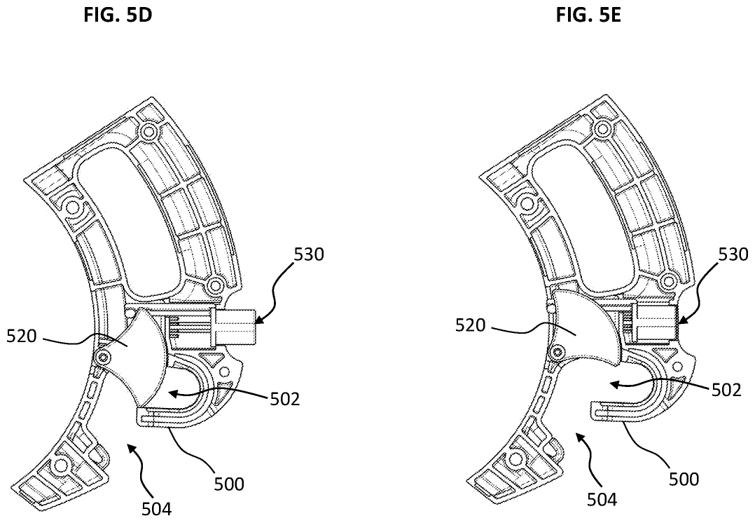

As shown in FIG. 1G the frame 120 includes a securing hook 500 in an inferior position relative to the fixed handle 128. The securing hook 500 allows the fence reel 100 to be hooked onto, and located at, a variety of locations-e.g. permanent fence wires, gates, parts of a vehicle such as pipework of an ATV's. Referring to FIGS. 5D and 5E, the securing hook 500 has a first opening 502 facing in an anterior direction towards the reel spool 110, and a second opening 504 between the frame 120 and the first opening 502, with the second opening 504 facing a posterior-inferior direction. The second opening 504 functions to funnel the component, to which the fence reel 100 is to be attached, to the first opening 502.

Referring to FIG. 5A to 5C, a barrier mechanism 510 is provided for selectively closing off the hook 500. The barrier mechanism 510 includes a barrier portion 520 which is selectively moveable to pivot between a closed position in which the barrier portion 520 extends at least partially across the first opening 502 (as shown in FIG. 5D), and a retracted position in which the barrier portion 520 is retracted into the frame 120 away from the first opening 502 (as shown in FIG. 5E). The barrier portion 520 includes side walls 522, a concave anterior facing surface 524, and convex posterior facing surface 526. The barrier portion further includes internal guide rails 528. The barrier portion 520 is actuated by a linear actuator in the form of a push button 530 and rod 532. The rod includes guide recesses 534 configured to receive the guide rails 528 of the barrier portion 520. Movement of the rod 532 causes the guide rails 528 to ride along the surfaces of the guide recesses and pivot the barrier portion 520. A spring (not illustrated), biases the push button 530 to a retracted position such that the barrier portion 520 is biased towards the closed position. In use, the component may act against concave anterior facing surface 524 to force the barrier portion 520 into an open position to facilitate attachment-but depression of the push button 530 is required to open the barrier portion 520 to release the component.

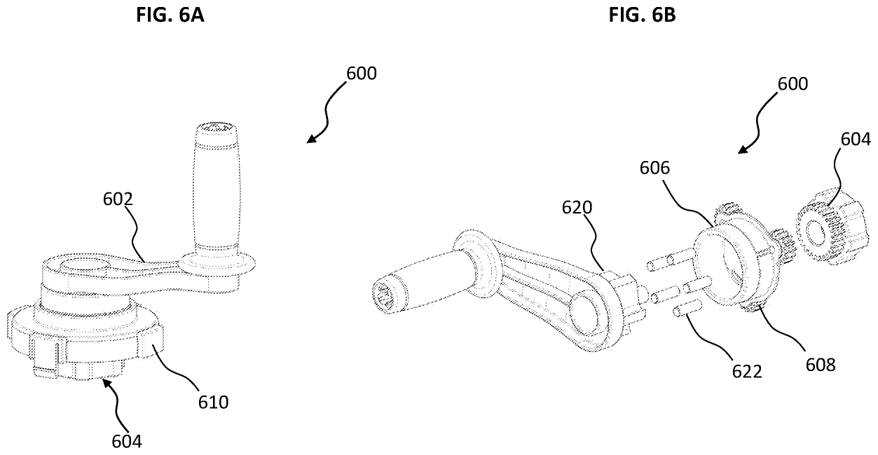

FIGS. 6A and 6B illustrate an alternative example of a winding handle 600, configured to engage the reel spool 110 in a first rotary direction, and permit rotation of the reel spool 110 independent of the winding handle 600 in the opposite direction. As a result, the handle 600 may be used to wind the wire in, but will not turn with the spool 110 as the wire is fed out. In this example, the winding handle 600 includes a crank 602, and a sun gear 604. The sun gear 604 is driven by planet carrier 606 having planet gears 608, in combination with ring gear 610 surrounding the planet gears 156. In this example, the winding handle 600 includes a one-way clutch formed from a freewheel portion 620 having a series of ramps in which rollers 522 are located. Rotation of the freewheel portion 620 in one direction causes the rollers to ride up the ramps and create an interference fit with the bore of the planet carrier 606, while in the other direction the rollers 522 remain in the ramps and do not produce the interference fit.

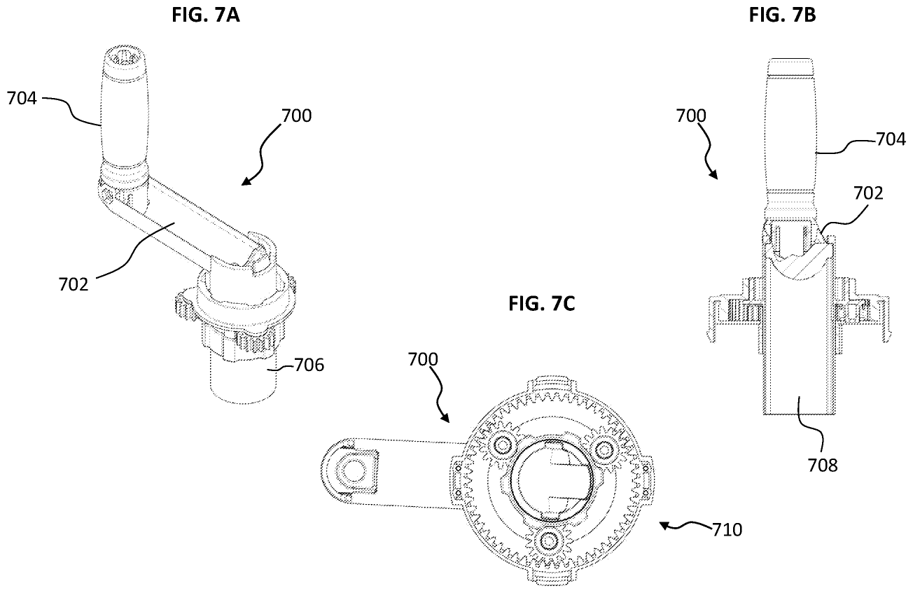

FIG. 7A to 7C illustrate an alternative example of a winding handle 700, configured to be retracted when not in use. The winding handle 700 includes a crank portion 702 and a handle portion 704 at an end of the crank portion 702. The handle portion 704 may fold relative to the crank portion 702, with the crank portion 702 including a recess to receive the handle portion 704 when folded. The winding handle 700 further includes a rotating component 706 to which the crank portion 702 is connected, having an internal bore 708. The crank portion 702 may be pivoted between an in-use orientation perpendicular to a longitudinal axis of the internal bore 708 (i.e. as shown in FIG. 7A to 7C), and a storage orientation aligned with the longitudinal axis of the internal bore 708. When in the storage orientation the crank portion 702 (and folded handle portion 704) may be slid along the longitudinal axis of the internal bore 708, between a stored position in which the crank portion 702 is substantially contained within the internal bore 708, and a retracted position in which the crank portion 702 is external to the internal bore 708 (i.e. as shown in FIG. 7A to 7C).

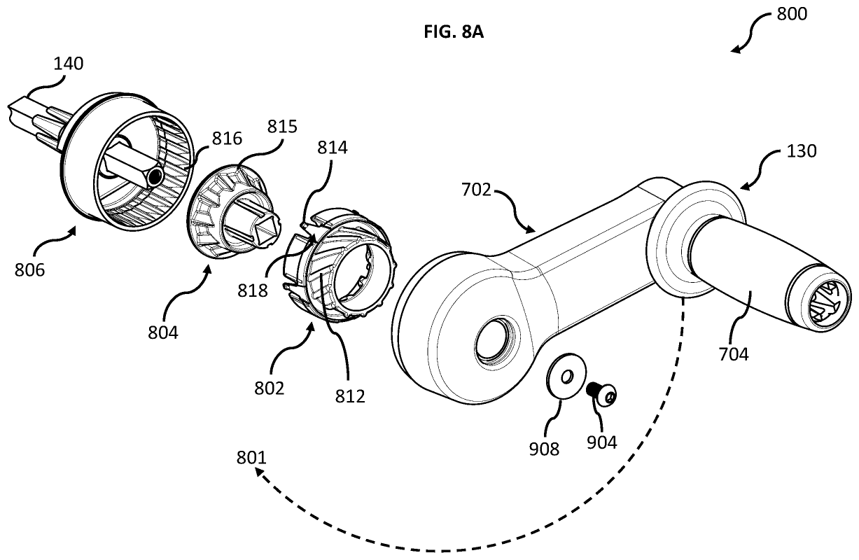

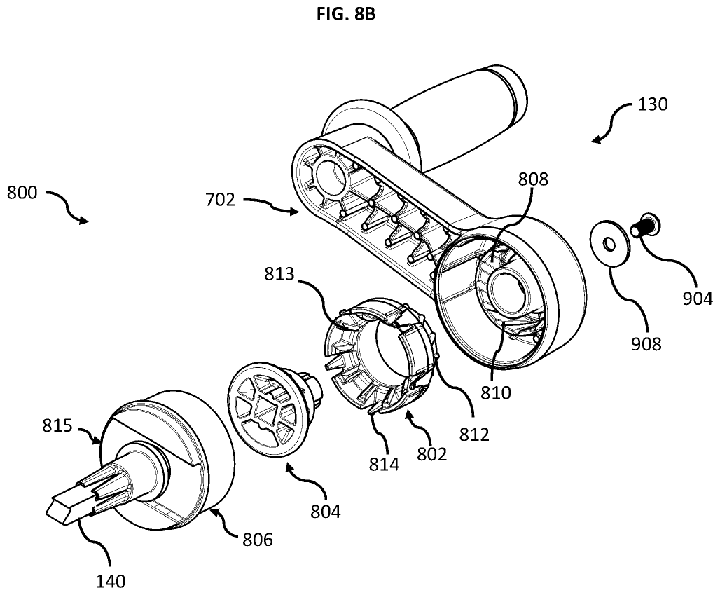

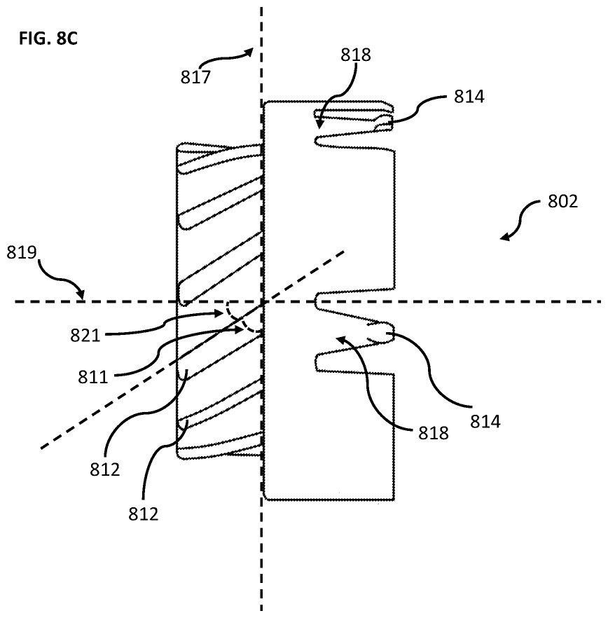

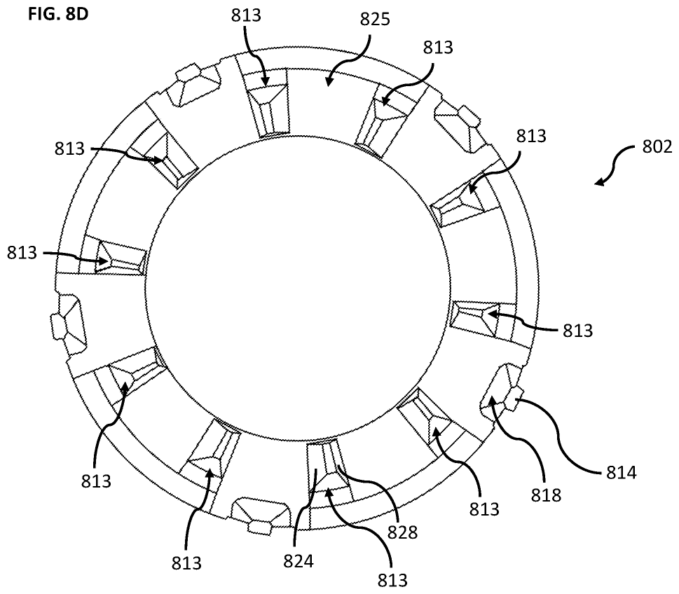

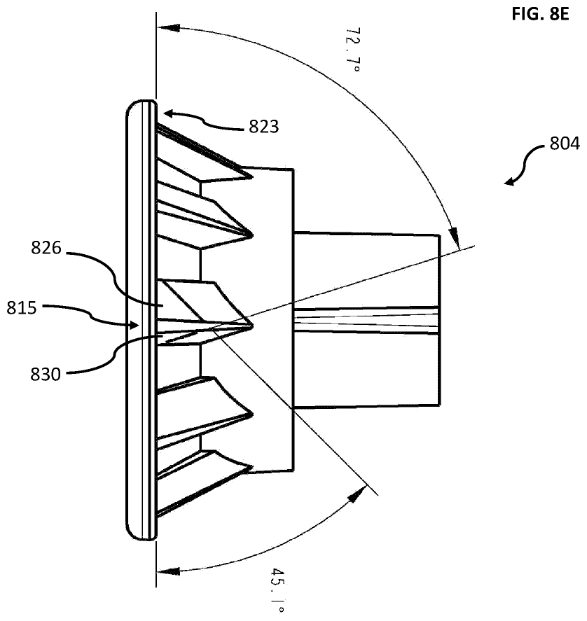

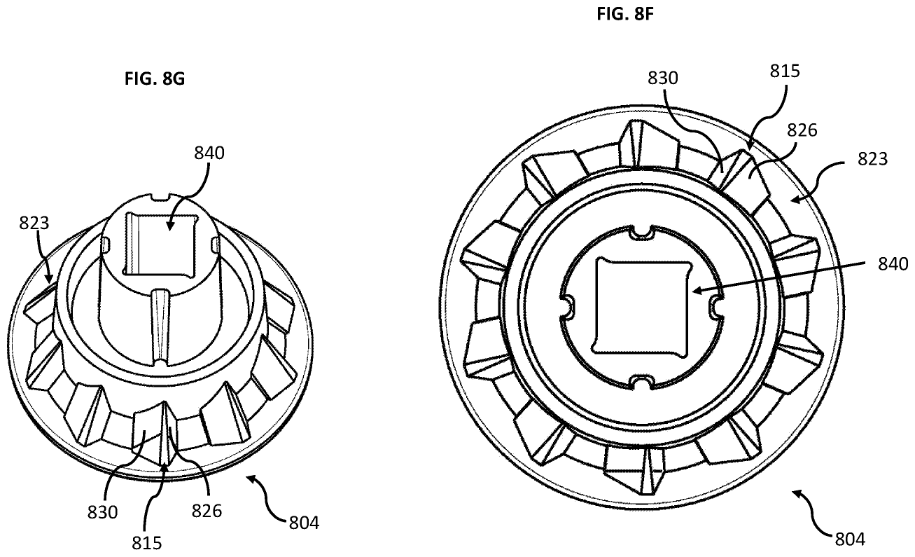

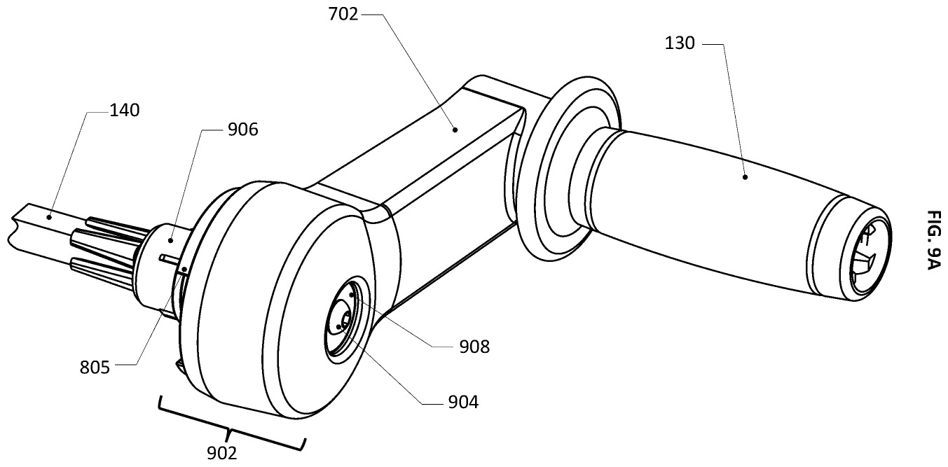

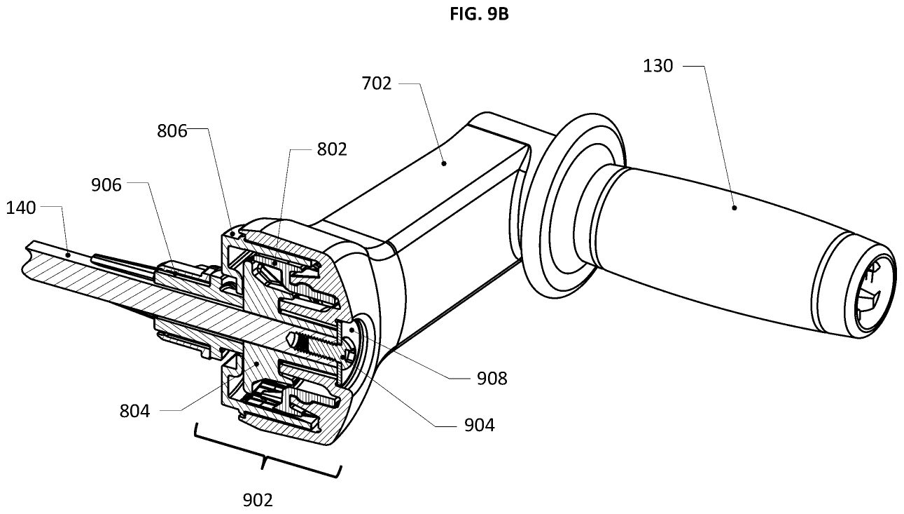

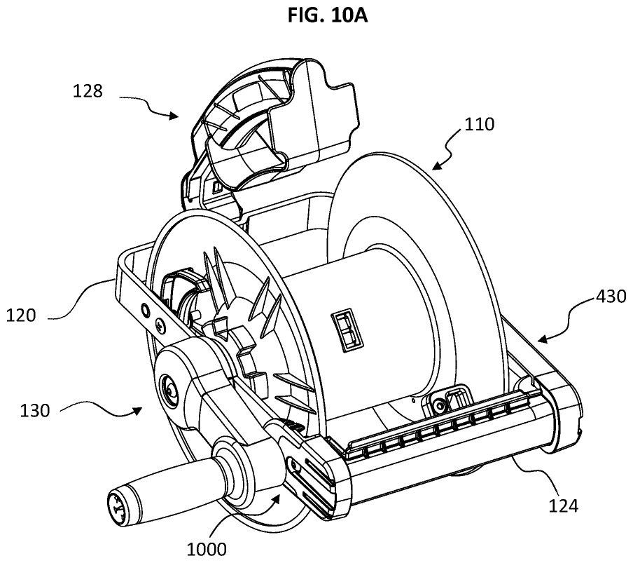

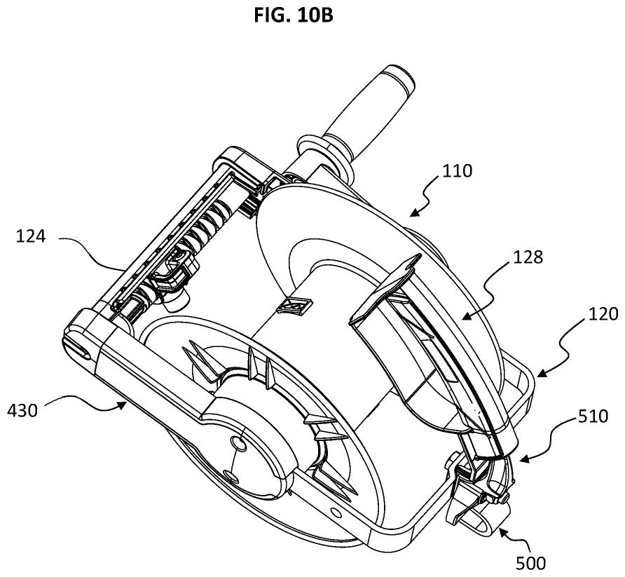

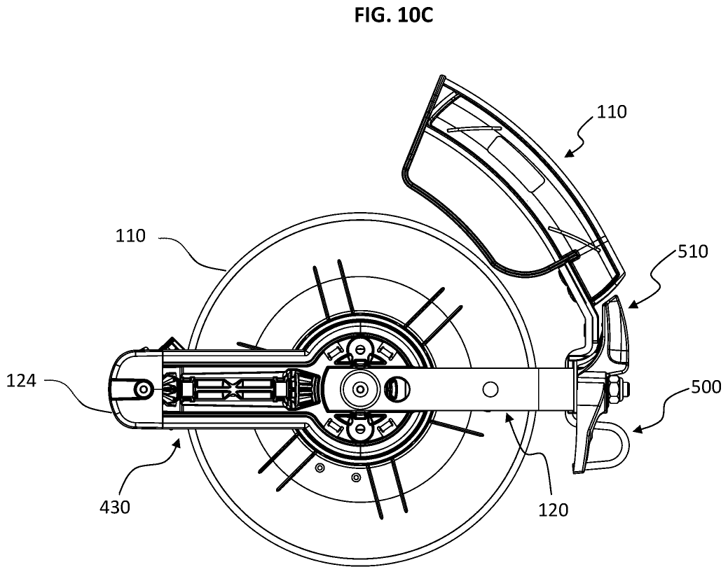

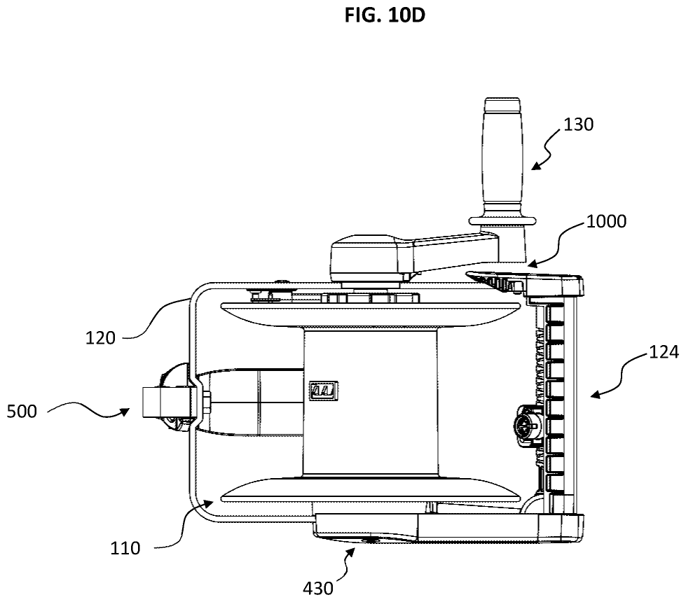

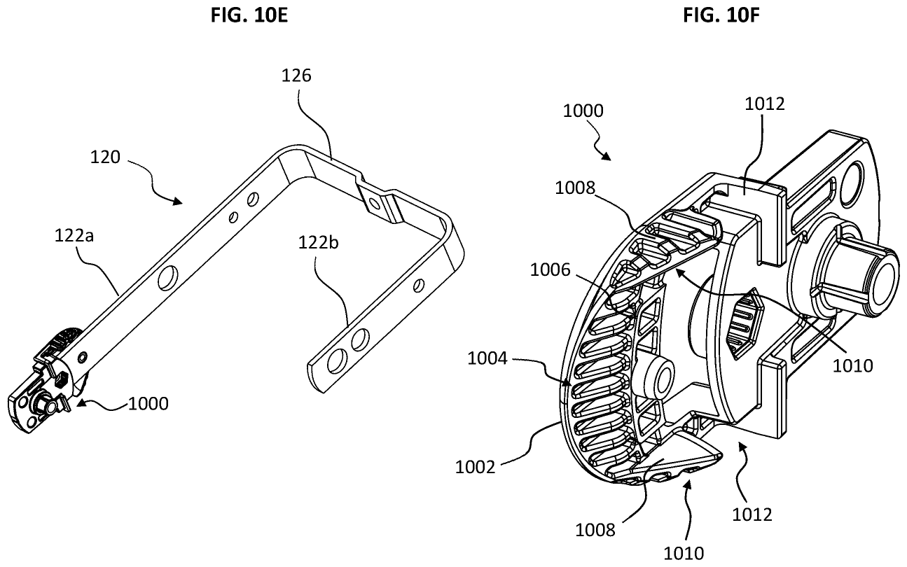

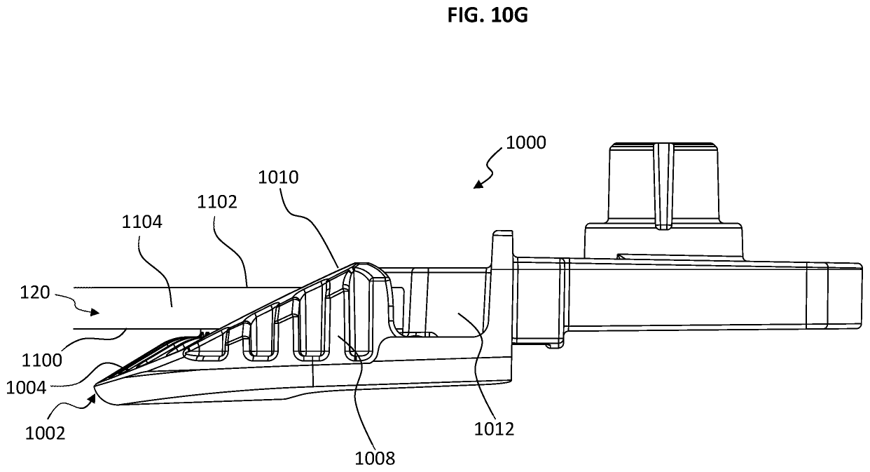

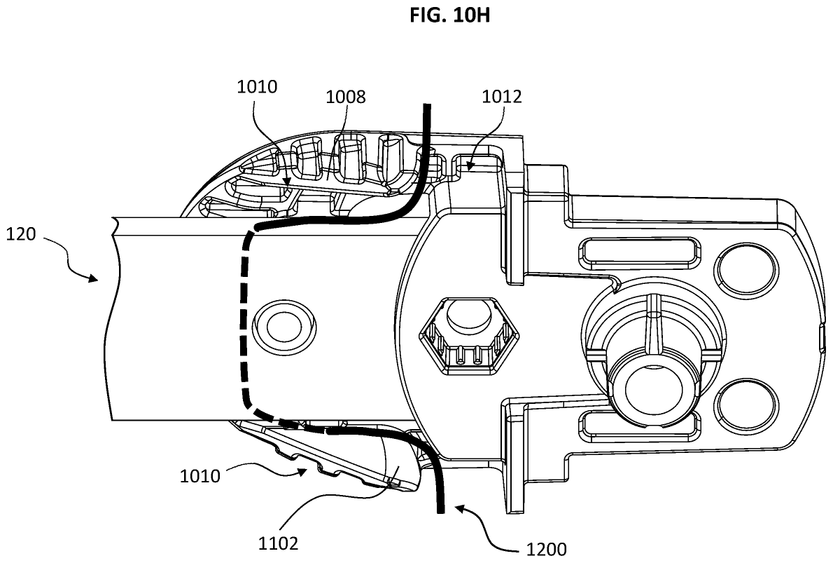

FIGS. 8A and 8B illustrate an exploded view of an automatic engaging mechanism 800 in which the winding handle 130 is configured to automatically engage with the reel spool 110 (e.g. as shown in FIGS. 10A to 10D) when wound in a given direction by a user (such as a clockwise direction 801), and automatically disengage from the reel spool 110 when the reel spool 110 is being driven from a source other than the winding handle 130 (such as winding in/spooling by the drive unit 200, or unwinding/unspooling by pulling the wire from the reel spool 110).

The automatic engaging mechanism 800 includes a clutch portion 802, a coupler 804 and a stationary reference 806. The clutch portion 802 is configured to slidably engage with the posterior side of the winding handle 130 (where the side of the handle 130 from which handle portion 704 extends is the anterior side), or more specifically the crank portion 702 of the winding handle 130. In the example shown (see, FIG. 8B) the posterior of the winding handle 130 has an internal support 808 in the form of a cylindrical wall including a series of helical channels 810. These helical channels 810 are preferably evenly spaced around the internal support 808 and correspond to helical protrusions 812 on the exterior of the clutch portion 802, such that the helical protrusions 812 can slide within the helical channels 810 in use to slidably connect the clutch portion 802 to the crank portion 702.

While in the examples shown the helical channels 810 are positioned on the internal surface of the internal support 808, in alternative examples: the helical channels 810 could be positioned on the external surface of the internal support 808 and the protrusions provided on a corresponding surface of the clutch portion 802, or the helical channels may be provided on the clutch portion 802 and the protrusions provided on the internal support 808.

In the illustrated example the channels and protrusions are provided in the form of a helical thread, however in alternative examples other suitable features may be used which encourage sliding movement between the clutch portion 802 and the winding handle 130. For example, one or more of the channels and protrusions may be provided as discrete, discontinuous engaging features. For example, the protrusions may have a pin type configuration, as is present in bayonet-type connectors. In another examples, discontinuous or interrupted screw threads may be used.

The protrusions 812 and channels 810 are positioned at an angle 811 with respect to the rotational axis of the clutch 817, which is perpendicular to longitudinal axis 819 of the crank shaft 140. In examples of the technology where a thread is used, this angle may be otherwise known as a helix angle 811 as should be familiar to those skilled in the art. The helix angle 811 should be understood as being related to the lead angle 821 which is measured with respect to the axis of translation 819 of the clutch such that the sum of the helix angle 811 and lead angle 821 should add to 90 degrees as shown in FIG. 8C.

In some examples the protrusions 812 and channels 810 may be configured to broadly resemble a helical gear as should be familiar to those skilled in the art.

In the illustrated example 12 pairs of helical channels 810 and protrusions 812 have been used to form a 12-start helical thread. Alternative examples of the number of protrusions 812 and channels 810 used are contemplated, for example between 3 and 36 pairs. The use of at least three pairs of helical channels 810 and protrusions 812 may assist with achieving even transfer of torque between the crank arm 702 and clutch portion 802, while reducing the ability of the clutch portion 802 to tilt within the crank arm 702 which can result in binding of the clutch portion (also referred to as racking).

While the foregoing has been illustrated with protrusions 812 on the clutch portion and channels 810 on the crank portion 702, it should be appreciated that alternative configurations are contemplated, for example the protrusions may be provided on the crank portion and channels on the clutch portion.

It may be advantageous for the present technology to be implemented using a number of protrusions 812 and channels 810 which is a factor of 360 degrees or are otherwise evenly spaced. This arrangement may allow for a clutch portion 802 which can engage with the crank portion 702 in any starting position. For example, the 12-start helical thread shown in FIGS. 8A and 8B may allow for the clutch portion 802 and crank portion 702 to engage with one another in any one of 12 different positions. However, this should not be seen as limiting, and any suitable engaging structure may be used irrespective of whether the protrusions 812 and channels 810 are evenly spaced. For example, an asymmetrical protrusion 812 and channel 810 arrangement may still allow for a sliding engagement between the clutch portion and crank portion 702, albeit in potentially fewer orientations relative to one another.

The protrusions 812 and channels 810 are configured to allow for translational movement of the clutch portion 802 along the axis of the crank shaft 140 in use. Translation of the clutch portion 802 along the axis of the crank shaft 140 in turn causes the clutch portion 802 to move relative to the coupler 804, and thereby allows for engagement of the clutch portion 802 with the coupler 804, for example using complementary engaging features, such as the coupler teeth and clutch teeth as described herein. As the coupler 804 is rotationally fixed to the crank shaft 140 (in this example using an aperture in the coupler 804 which has a complementary shape to the crank shaft, such as a square aperture and a square crank shaft), further rotation of the clutch portion 802 results in rotation of the crank shaft 140, which in turn causes rotation of the reel spool 110.

To encourage the clutch portion 802 to translate along the axis of the crank shaft 140, the clutch portion 802 includes one or more clutch resistance features 814 in the form of radially outward protrusions which are configured to engage with the stationary reference 806 to provide a resistance against the rotation of the clutch portion 802. In alternative examples the clutch resistance features may instead be configured to extend radially inwardly, to engage with a stationary reference provided on the interior of the clutch portion. The stationary reference 806 preferably has a circular or ring-shape, which is configured to be stationary or otherwise fixed relative to the frame 120 of the reel. For example, the stationary reference 806 can be configured to mount directly to the frame 120.

In the example shown, the clutch resistance features 814 are configured to engage with corresponding reference resistance features 816 in the form of a corrugation or ribs on the interior or inside surface of the stationary reference 806. The engagement of the clutch resistance features 814 with the reference resistance features 816 provides a resistance to rotation of the clutch portion 802 due to interference between the clutch resistance features 814 and the reference resistance features 816, or otherwise due to the friction provided between the clutch resistance features 814 and reference resistance features 816. This resistance opposes the rotation of the clutch portion 802, as the crank arm 702 is wound by the user.

The winding of the crank arm 702, together with the angles of the protrusions 812 and channels 810 results in the rotational force provided by the crank arm 702 imparting rotational and translational forces to the clutch portion 802. The ratio of the rotational force to the translational force is adjustable by varying the helix angle (otherwise referred to as the angle relative to the axis of rotation of the clutch portion 802). Without a stationary reference 806 the clutch portion 802 could continue to rotate within the crank arm 702 and not translate to engage with the coupler 804, accordingly the stationary reference 806 provides some resistance against continued rotation of the clutch portion 802 within the crank arm 702, thereby encouraging it to translate towards the coupler 804. It should be appreciated that the clutch portion 802 may both rotate and translate simultaneously, or alternatively may not rotate during translation into engagement with, or disengagement from, the coupler 804. In other words, the stationary reference 806 is configured to encourage translation of the clutch portion 802 along the longitudinal axis of the crank shaft 140.

In preferred examples of the technology, the helix angle, or the angle of the protrusions and channels relative to the rotational axis of the clutch portion 802 is between approximately 70 and 40 degrees, such as between 60 and 50 degrees, or more preferably approximately 55 degrees.

Accordingly, the engagement of the clutch resistance features 814 with the reference resistance features 816 provides the clutch portion 802 with a slight resistance to rotation while providing minimal resistance to longitudinal movement along the axis of the crank shaft 140, thereby encouraging the clutch portion 802 to translate or otherwise move along the crank shaft 140 away from the crank arm 702 towards the coupler 804.

The reference resistance features 816 are spaced such that the valleys of the corrugations align with the resistive protrusions 814 so that when one protrusion is located in a valley all protrusions are located in a valley. This reduces the frictional forces acting against the clutch portion 802 when it is travelling along the axis of the crank shaft 140 from a disengaged position to an engaged position or vice versa. In the example given there are five fingers, each with a protruding resistance feature 814. In this case the number of corrugations is preferably a number divisible by five, for example 30, and with a valley width and depth that can allow a protruding resistance feature 814 on the finger of the clutch portion 802 to travel along a valley with minimal interference, preferably some clearance and hence very low friction. In the example shown there are 30 peaks and valleys around the inner circumference of the stationary reference 806. When any one of the resistive protrusions 814 is up against a surface of a corrugation all five of the resistive protrusions 814 is up against a surface of a corrugation and so maximises the overall available friction against rotation of the clutch portion 804 for a given resistance value between a resistive protrusion 814 and the stationary reference 806. The use of a plurality of fingers can reduce the likelihood of the clutch portion 802 tilting with respect to the axis of rotation, which could cause the clutch portion 802 to bind within the stationary reference 806, and/or the crank arm 702 (known as racking).

The use of protrusions as clutch resistance features 814 and ribs as reference resistance features 816 should not be seen as limiting on the technology, and any suitable mechanism may be used which provides the clutch portion 802 with resistance to rotational movement, including a smooth internal bore on the stationary reference. For example, the protrusions of the clutch resistance features 814 may be replaced with a rolling element, such as a ball, and/or the ribs of the clutch resistance features 816 may be replaced with a substantially smooth or textured internal surface.

In the example illustrated the clutch resistance features 814 are provided to a resilient finger 818, allowing the clutch resistance features 814 to move inwardly and outwardly relative to the crank shaft 140. In the illustrated example, the resilient finger 818 has a tapered neck preferably constructed of a resilient material such as a plastic or metal. However, in alternative examples another suitable resilient support member may be used, such as a compression spring, torsion spring, clock spring or leaf spring.

In use the resilient finger 818, allows for the clutch resistance features 814 to move inwardly towards the crank shaft 140 in situations where the clutch portion 802 is required to rotate relative to the stationary reference. For example, when the clutch portion 802 has fully engaged with the coupler 804 it is desirable for the clutch portion 802 to rotate, to transfer torque to the coupler 804, and therefore the crank shaft 140. In this situation, the resistance to translational movement of the clutch portion 802 will be provided by the engagement of the clutch portion 802 with the coupler 804, and the rotational forces imparted from the crank arm, will exceed the frictional forces applied between the clutch resistance features 814 and ribs 816 resulting in torque transfer to the coupler 804.

The axially outward surface 823 of the coupler 804, facing the clutch portion 804, is provided with features configured to engage with corresponding features on the axially inward surface 825 of the clutch portion 802. In the example illustrated in FIG. 8A to 8F, the features include coupler teeth 815 and clutch teeth 813.

The coupler teeth 815 are configured to in use engage with the clutch teeth 813 to provide torque transfer between the clutch portion 802 and coupler 804.

In the illustrated examples shown in FIG. 8D to 8G, the clutch teeth 813 and coupler teeth 815 are each provided with an asymmetric shape. For example, the clutch teeth 813 include a first face 824, which is configured to engage with a corresponding first face 826 of the coupler teeth 815 when the clutch portion 802 is rotated in a first direction relative to the coupler 804 (e.g. counter-clockwise). The first faces 824, 826 may be referred to herein as “release” faces of the teeth 813, 815. The clutch teeth 813 further include a second face 828, which is configured to engage with a corresponding second face 830 of the coupler teeth 815 when the clutch portion 802 is rotated in a second direction relative to the coupler (e.g. clockwise). The second faces 828, 830 may be referred to herein as “drive” faces of the teeth 813, 815.

In the examples illustrated in FIG. 8D to 8G, the release and drive faces are provided at an acute angle relative to the respective surfaces 825, 823. When the crank arm is being driven, thereby encouraging the clutch portion 802 to engage with the coupler 804, the engaging force should be greater than the separation force provided by the respective faces of the coupler 804. However when the crank arm 702 is no longer driven by the user, this separation force can advantageously encourage separation of the clutch portion 802 from the coupler 804, allowing the coupler 804 to continue to turn without requiring continued turning of the crank arm 702. This provides the reel with a “free-wheeling” action, independent of the crank arm 702, which is otherwise not present in traditional fence reels. This can allow the user to have a small break in the winding of the reel, or to select an arc from the circle of full rotation where the rotational force is applied to the handle. Such selective application of force gives greater control to the user in terms of what is most efficient or comfortable for them, and may assist with reducing fatigue and alleviating associated health and safety concerns. Similarly, when the spool 110 is being driven (either by a user unspooling the wire, or from a drive means as described herein), the separation forces provided by the acute angled surfaces can encourage separation of the clutch portion 802 from the coupler 804, and therefore the crank arm 702 from the crank shaft 140, automatically preventing rotation of the crank arm 702 as the spool 110 turns.

It should be appreciated that the angles of the release faces 824, 826 may be configured with an angle relative to the surfaces 825, 823 such that when the clutch portion 802 is turned in a first direction relative to the coupler 804, the separation forces are relatively high, that is to say that the release faces 824, 826 engage with each other to encourage separation. For example the release faces 824, 826 may be provided with an acute angle which of substantially 45 degrees, such as between 30 and 50 degrees. In the example shown in FIG. 8E the angle is 45.1 degrees. Generally, the less steep the angle the greater the releasing force. However, there are physical constraints to how low the angle can go without taking up too much space per tooth 813, 815. Further, the releasing force exerted by the teeth 813, 815 interaction has to overcome the translation force applied by the complementary translation features while also being minimal when the handle is not having force applied to it.

Conversely, when the clutch portion 802 is turned in a second direction relative to the coupler 804, the drive faces 828, 830 may be configured to engage and provide a comparatively low separation force, for example the acute angle of the drive faces 828, 830 may be approximately 70 degrees, such as between 60 and 90 degrees. In examples the angle of the drive faces 828, 830 may be less than 90 degrees. In the example shown in FIG. 8E the angle is 72.7 degrees.

The difference in angle of the release faces 824, 826 relative to the drive faces 828, 830 allows for positive torque transfer from the crank arm 702 through the clutch portion 802 and coupler 804 into the crank shaft 140 when wound in one direction (in this example, the second direction or clockwise), and higher separation forces when the spool 110 is free-wheeling or when the crank arm 702 is wound in the opposite direction (in this example, the first direction or counter-clockwise).

In the illustrated examples, the automatic engaging mechanism 800 is configured such that clockwise rotation of the handle relative to the body of the reel, results in the wire being wound onto the spool. Accordingly, the features illustrated in the figures are configured such that the clockwise rotation of the crank arm results in a winding in of the wire.

For example, in the examples illustrated in the figures, clockwise rotation of the crank arm 702, provides a force to the clutch portion 802 which encourages the clutch portion 802 to travel axially inwardly, and engage with the coupler 804. For example, the protrusions 812 and channels 810 may be provided with a left-handed thread direction, such that as the crank arm 702 is rotated clockwise, the resulting force component applied to the clutch portion 802 in the axis of the crank shaft 140 is outwardly from the crank arm 702, or inwardly towards the coupler 804. Similarly, the ribs 816 on a radially inward facing surface of the stationary reference may be provided with a saw-toothed profile, such that the ribs 816 provide a greater rotational resistance to the clutch portion 802 rotating in a counter-clockwise direction, than the ribs 816 may provide to rotation in a clockwise direction.

Furthermore, the coupler teeth 815 on the coupler 804 and/or clutch teeth 813 on the clutch portion 802 may be configured to provide complementary engaging features, when the clutch portion 802 is rotating in a clockwise direction, to transfer the rotational force to the coupler 804 and therefore to the crank shaft 140 of the reel. Conversely, the coupler teeth 815 and clutch teeth 813 may be configured such that the release faces provide complementary disengaging surfaces under certain conditions, such that rotation of the coupler 804 in a clockwise direction at a faster speed than the clutch portion 802 (for example when freewheeling) can result in the clutch portion 802 being encouraged back towards the crank arm 702, thereby disengaging the crank arm from the shaft and allowing the crank shaft 140 to turn freely without the crank arm 702 rotating.

It should be appreciated that while the foregoing is discussed in relation to clockwise rotation of the crank arm 702, the features described herein may be inverted so as to provide transfer of torque from the crank arm 702 to the crank shaft 140 when rotated in a counter-clockwise direction.

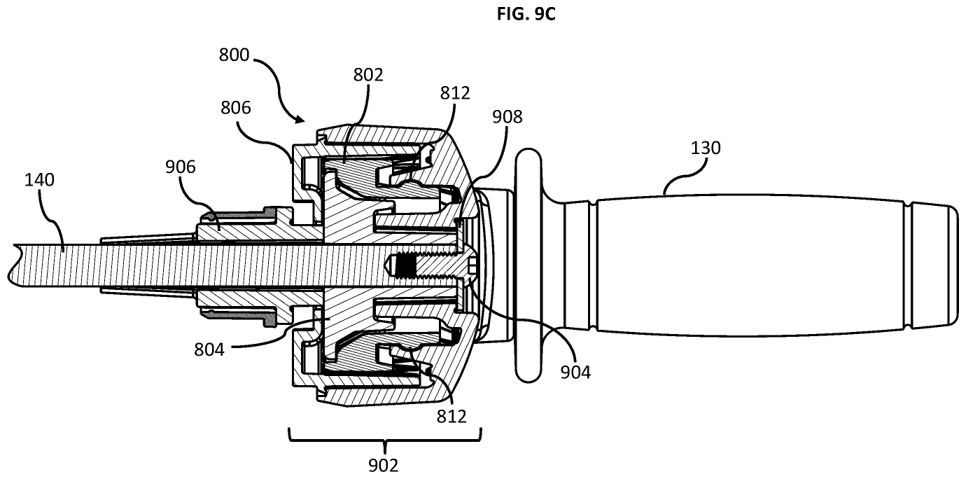

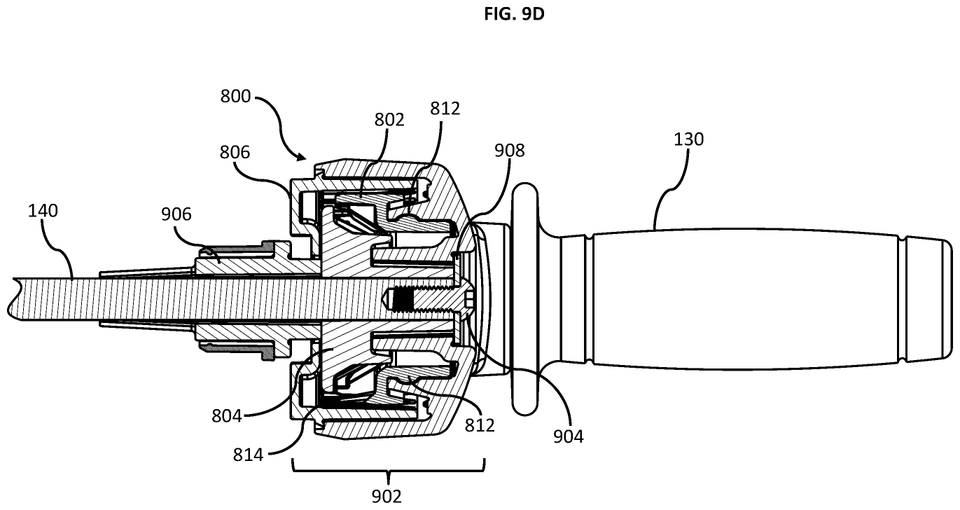

In use the crank arm 702, clutch portion 802, coupler 804 and stationary reference 806, are combined within an automatic engaging housing 902 formed between the crank arm 702 and stationary reference 806 as shown in FIGS. 9A and 9B. The automatic engaging housing 902 is secured to the crank arm 702 using a fastener 904 and a sleeve 906. The fastener 904 may be a screw or bolt configured to engage with a complementary internal thread in the crank shaft 140. In another example the fastener may be a nut configured to engage with an external thread on the crank shaft 140. A washer 908 may also be positioned under the fastener, to provide a bearing surface which further resists removal of the automatic engaging housing 902 from the crank shaft 140. The sleeve 906 may have a complementary internal shape to the crank shaft 140 or otherwise be, adhered or fastened to the crank shaft 140 to resist removal during use.

FIG. 9C. shows the automatic engaging mechanism 800 in a first position in which the clutch portion 802 is engaged with the coupler 804, and FIG. 9D shows the automatic engaging mechanism 800 in a second position in which the clutch portion 802 is disengaged from the coupler 804. In use rotation of the winding handle 130 in a clockwise direction, causes the clutch portion 802 to move towards the coupler 804 until the clutch portion 802 engages with the coupler 804. Further rotation of the winding handle 130 in the clockwise direction causes rotation of the clutch portion 802, which in turn causes rotation of the coupler 804, and the crank shaft 140.

It should be appreciated that in this example of the technology, the coupler may be, but is not required to be translationally fixed relative to the crank shaft. For example, the coupler may be substantially free to slide along the crank shaft within the confines of the automatic engaging housing 902, while at the same time being rotationally fixed to the crank shaft, for example by way of an aperture 840 in the coupler which has a complementary shape to the crank shaft.

The foregoing technology allows for a freewheeling action during the winding process which may be beneficial to reduce user fatigue and repetitive strain type injuries. For example, when the user rotates the winding handle 130 in a clockwise direction, the clutch portion 802 engages with the coupler 804 to cause rotation of the crank shaft, and therefore the reel spool 110 as described herein. The rotating reel spool has rotational inertia, such that if the user was to stop winding the winding handle, the crank shaft 140 would continue to rotate with the reel spool (via a ratio set by the gearbox as described herein). The rotation of the shaft relative to the stationary winding handle causes the clutch portion 802 to disengage from the coupler 804, and travel outwardly along the axis of the crank shaft towards the winding handle, thereby disconnecting the winding handle from the crank shaft. Accordingly, the reel spool and crank shaft can continue to spin without the winding handle spinning around. This can provide the user with a small rest during the winding process, reducing fatigue.

It should be appreciated that the automatic engaging mechanism 800 described herein may have additional benefits when used in combination with the drive units described herein, as it allows for an automatic change between the winding source, whether it be manual winding of the winding handle or winding via the drive source.

It should be appreciated that the automatic engaging assembly as described could easily have applications outside of the electric fence reel application. This could include such applications as fishing reels, cord reels, hose reel or any application where it is advantageous to have a crank handle automatically disengage from a spool or drum where the disengagement automatically occurs when the drum is rotating faster than the crank is driven or where the drum is rotated in reverse from the rotation when being driven by the crank handle and the engagement is initiated by the winding the crank. The advantages may include one or more of: a very low parts count and cost, automatic disengagement without the user having to intervene by selecting an engaged or disengaged mode. The assembly can be made using injection moulded parts although often the crankshaft may still be a metal part although not necessarily.

FIG. 10A to FIG. 10D illustrate another example of a portable fence reel 100 according to one aspect of the present technology. In this example, a handle 128 is provided on the frame 120, for handling of the fence reel 100. In this example the handle 128 is configured to be releasably secured to the frame 120, so that when released it is able to be pivoted through 180 degrees to suit a desired handle/winding handle orientation depending on whether the user is left or right handed. In this example, the securing hook 500 is provided inferior to the handle 128 in use, with a pivoting barrier mechanism 510 that may be actuated by the user to block and unblock the securing hook 500.

It can be advantageous for portable fence reels to include a means for conducting the electric pulses provided from a fence line to the wire on the reel. In this way, the reel may be attached to an existing, energized fence line, and receive the electric pulses from the fence line, in order to conduct the electric pulses through the wire, and into any temporary fencing structure provided by the portable fence reel. In one example of the technology, the securing hook 500 and frame 120 may include an electrically conductive portion, such that when the reel is secured to a fence, and the fence is energized, the electric pulses from the fence are conducted into the frame of the reel 120.

In this example, the fence reel 100 includes a strand connection feature 1000 configured to secure the conductive strand in contact with an electrically conductive portion of the fence reel 100. Referring to FIG. 10E, in this example the frame 120 includes an electrically conductive portion, including lateral frame portions 122 joined by posterior frame portion 126. In this example the lateral frame portions 122 include a full lateral frame portion 122a and a partial lateral frame portion 122b. In such an embodiment, a support structure for the drive mechanism 430 bridges between the partial lateral frame portion 122b and the anterior frame portion 124 (see FIG. 10A-10D). In this example the strand connection feature 1000 is provided to the full lateral frame portion 122a. The strand connection feature 1000 may be located near the front of the reel 100, where the wire exits the spool 110, so that it pulls the conductive securing hook 500 against the fence wire to which the reel is secured to enhance the conductive contact between the wire and the frame 120.

Referring to FIG. 10F, in examples the strand connection feature 1000 includes a leading portion 1002 having a sloped surface 1004 provided by ribs 1006. In examples the strand connection feature 1000 includes a guide flange 1008 on each lateral side of the leading portion 1002. In examples each guide flange 1008 includes a guide edge 1010 sloping away from the leading portion 1002. In examples the strand connection feature 1000 includes a recess 1012 provided at an end of each guide edge 1008 distal from the leading portion 1002.

Referring to FIG. 10G, the frame 120 includes an outer surface 1100, an outer surface 1102, and sides 1104. The sloped surface 1004 of the strand connection feature 1000 leads from a first position offset from the outer surface 1100 of the frame 120 to a second position proximate the outer surface 1100 of the frame 120. In use, the conductive strand (not illustrated) is guided by the sloped surface 1004 to contact the frame 120. In examples, the guide edges 1010 of the guide flanges 1008 extend from a position offset from the outer surface 1100 to beyond the inner surface 1102 so as to overlap the outer surface 1100 of the frame 120. The recesses 1012 then drop in the other direction.

Referring to FIG. 10H, in use a conductive strand 1200 may be positioned along a pathway through one recess 1012, between the guide flange 1008 and the frame 120, between the sloped surface 1004 and the frame 120, between the other guide flange 1008 and the frame 120, and through the other recess 1012.

The illustrated embodiments of the disclosure will be best understood by reference to the figures. The foregoing description is intended only by way of example and simply illustrates certain selected exemplary embodiments of the disclosure.

The entire disclosures of all applications, patents and publications cited above and below, if any, are herein incorporated by reference. Reference to any prior art in this specification is not, and should not be taken as, an acknowledgement or any form of suggestion that that prior art forms part of the common general knowledge in the field of endeavour in any country in the world.

The invention(s) of the present disclosure may also be said broadly to consist in the parts, elements and features referred to or indicated in the specification of the application, individually or collectively, in any or all combinations of two or more of said parts, elements or features. Where in the foregoing description reference has been made to integers or components having known equivalents thereof, those integers are herein incorporated as if individually set forth.

Furthermore, the described features, structures, or characteristics may be combined in any suitable manner in at least one embodiment. In the foregoing description, numerous specific details are provided to give a thorough understanding of the exemplary embodiments. One skilled in the relevant art may well recognize, however, that embodiments of the disclosure can be practiced without at least one of the specific details thereof, or can be practiced with other methods, components, materials, et cetera. In other instances, well-known structures, materials, or operations are not shown or described in detail to avoid obscuring aspects of the invention.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps, that is to say, in the sense of “including, but not limited to”.

Aspects of the present disclosure have been described by way of example only and it should be appreciated that modifications and additions may be made thereto without departing from the scope thereof.

1. A portable fence reel, including:
a reel spool;
a frame, the frame including at least one arm, wherein the reel spool is rotatably mounted to the at least one arm;
a crank shaft, wherein rotation of the crank shaft results in rotation of the reel spool;
a winding handle; and
an automatic engaging mechanism including:
a coupler rotationally fixed to the crank shaft; and
a clutch portion configured to be driven by the winding handle and, in use, move along a longitudinal axis of the crank shaft to engage or disengage with the coupler, wherein the automatic engaging mechanism is configured such that, in use:
rotation of the winding handle moves the clutch portion between a first position in which the clutch portion is disengaged from the coupler, and a second position in which the clutch portion is engaged with the coupler such that rotation of the winding handle causes rotation of the crank shaft, and therefore the reel spool, and
rotation of the reel spool independently of the winding handle causes the clutch portion to disengage with the coupler to disconnect the winding handle from the crank shaft.

2. The portable fence reel of claim 1, further including a stationary reference which is fixed relative to the frame.

3. The portable fence reel of claim 2, wherein the clutch portion is configured to interact with the stationary reference to provide the clutch portion with a resistance against rotation.

4. The portable fence reel of claim 3, wherein the stationary reference includes an annular radially inward facing surface which is configured to interact with the clutch to provide the resistance against rotation.

5. The portable fence reel of claim 3, wherein the clutch portion includes clutch resistance features configured to interact with the stationary reference to provide the clutch portion with the resistance against rotation.

6. The portable fence reel of claim 1, wherein the clutch portion and the winding handle include complementary translation features.

7. The portable fence reel of claim 6, wherein the complementary translation features include protrusions and channels, or complementary threads.

8. The portable fence reel of claim 1, wherein the coupler and clutch portion include complementary engaging features configured to engage with one another to transfer rotational forces from the clutch to the coupler, and through to the reel spool.

9. The portable fence reel of claim 8, wherein the complementary engaging features include clutch teeth and coupler teeth, wherein the clutch teeth and/or coupler teeth include a first side configured to transfer rotational forces from the clutch to the coupler, and a second side configured to encourage disconnection of the clutch from the coupler.

10. The portable fence reel of claim 1, further including a strand connection feature configured to connect a conductive strand on the reel spool with the frame of the reel spool to provide an electrically conductive connection.

11. The portable fence reel of claim 1, further including a traverse winder mechanism configured to guide feeding of the wire across a barrel of the reel spool between the annular flanges as the reel spool rotates, wherein the traverse winder mechanism includes:
a rotating shaft extending across the reel spool and including include an external helical track;
a wire guide carriage including a track follower configured to engage with the helical track in order to guide the wire guide carriage across the shaft as the shaft rotates, and a guide passage configured to locate the wire relative to the carriage.

12. The portable fence reel of claim 11, wherein the frame includes an anterior frame portion including a posterior facing surface including a superior raised bearing feature having a first bearing surface, and wherein the wire guide carriage includes an anterior protrusion having a first anterior bearing surface configured to bear against the first bearing surface in use.

13. The portable fence reel of claim 12, wherein the posterior facing surface of the anterior frame portion further includes an inferior raised bearing feature having a second bearing surface, and wherein an external surface of the wire guide carriage is configured to bear against the second bearing surface in use.
